(19) United States
(12) Patent Application Publication
(10) Pub. No.: US 2011/0276901 A1
(43) Pub. Date: Nov. 10, 2011

(54) FAMILY CHAT

(75) Inventors: Nicholas Zambetti, San Francisco, CA (US); Jesse Tane, San Francisco, CA (US); Katrin B. Gosling, Woodside, CA (US); Afshin Frederick Mehin, San Francisco, CA (US); Coe Leta Rayne Stafford, Millbrae, CA (US); Martin Nicholas John Heaton, San Francisco, CA (US); Astrid Van Der Flier, San Francisco, CA (US); Michael Gibson, Evergreen, CO (US); Richard Cerami, Denver, CO (US)

(73) Assignee: Qwest Communications International Inc., Denver, CO (US)

(21) Appl. No.: 12/773,747

(22) Filed: May 4, 2010

(51) Int. Cl. G06F 3/01

(52) U.S. Cl. 715/753

(57) ABSTRACT

Systems and methods are described for handling graphical interfacing with a group conversation involving a communications hub and multiple member devices. Embodiments provide a “family chat” communications mode for facilitating a synchronous conversation among all the members of the designated family group. Typically, the conversation may involve a user supersystem (e.g., including one or more graphical communications devices) associated with the family and disposed with the family's local network, and member devices associated with each member of the family group (e.g., cell phones, etc). In some embodiments, the family chat conversation is displayed (e.g., rendered) as a substantially continuous feed graphically indicating the party contributing each message to the feed, the temporal relationship of the various contributions, and other useful information.

### FIELD

The present invention relates, in general, to communications networks and services and, more particularly, to substantially synchronous communications among a defined group of users.

### BACKGROUND

In many typical communications environments, users interact with communications services through a local network. For example, users within a home, office, enterprise branch location, etc. may interface with outside networks through routers and/or other network access systems. As voice, video, Internet, and other types of communications services converge, and as user network devices become increasingly portable, the network access systems are increasingly becoming hubs for substantially all user communications in proximity to the user's local network.

The increase in convergence and portability has provided many new types of user devices for interacting with communications services through the user's local network. However, there is typically little interactivity between the devices. As such, it may be difficult and/or inconvenient to use the devices in an integrative fashion, for example, to facilitate an integrated family or office environment.

### BRIEF SUMMARY

Among other things, systems and methods are described for handling graphical interfacing with a group conversation involving a communications hub and multiple member devices. Embodiments provide a “family chat” communications mode for facilitating a synchronous conversation among all the members of the designated family group. Typically, the conversation may involve a user supersystem (e.g., including one or more graphical communications devices) associated with the family and disposed with the family's local network, and member devices associated with each member of the family group (e.g., cell phones, etc). In some embodiments, the family chat conversation is displayed (e.g., rendered) as a substantially continuous feed graphically indicating the party contributing each message to the feed, the temporal relationship of the various contributions, and other useful information.

According to one set of embodiments, a hub system is provided for displaying a group conversation transpiring over a communications network. The hub system is disposed within a local portion of the communications network and includes: an input subsystem; a contribution processing subsystem, and an output subsystem. The input subsystem is configured to receive a first contribution message via an input device from a first member of a conversation group (having at least three members). The contribution processing subsystem is configured to receive the first contribution message from the first member of the conversation group via the input subsystem, and to receive a second contribution message from a second member of the conversation group via a member device. The output subsystem is configured to display at least a portion of the first contribution message to a first region of a display device designated for displaying contribution messages originating from the input subsystem as internal messages, and to display at least a portion of the second contribution message to a second region of the display device designated for displaying contribution messages originating from other than the input subsystem as external messages.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1A shows a simplified block diagram of an illustrative user supersystem in communication with a provider network, according to various embodiments.

FIG. 1B shows a simplified block diagram of another illustrative user supersystem in communication with a provider network, where the base station system provides little or no communications functionality, according to various embodiments.

FIG. 1C shows a simplified block diagram of yet another illustrative user supersystem in communication with a provider network, where the base station system physically interfaces only with the tablet system, and where certain standard tablet system and handset system components are used, according to various embodiments.

FIG. 2 shows a communications system that includes a user network having multiple clients, according to various embodiments.

FIG. 3 shows a communications system that includes multiple user networks, according to various embodiments.

FIG. 4 shows a functional block diagram of a base station system in the context of certain other devices and systems, according to various embodiments.

FIG. 5 shows a functional block diagram of a client subsystem in the context of certain other devices and systems, according to various embodiments.

FIG. 6 shows a simplified block diagram of an illustrative computational system for use in implementing components of various embodiments.

FIG. 7 illustrates an embodiment of a family communications environment.

FIGS. 8A-8C show various types of context-driven communications that may be facilitated via the user supersystem, according to various embodiments.

FIG. 9 shows a simplified communications system view of communications modes, such as those illustrated by the embodiments and examples of FIGS. 8A-8C, according to various embodiments.

FIG. 10 shows a flow diagram of an illustrative method for using contextual factors to drive communications mode determinations, according to various embodiments.

FIGS. 11A and 11B show additional approaches to context-driven communications mode determinations, according to various embodiments.

FIG. 12 shows an illustrative display configuration for a family chat mode, according to various embodiments.

FIG. 13 shows an illustrative screenshot of a portion of a family chat conversation rendered within a family chat region of a user supersystem display, according to various embodiments.

FIG. 14 shows a screenshot of an illustrative chat contribution interface.

FIGS. 15A-15C show illustrative screenshots of a portion of a family chat conversation rendered within a family chat region of a member device display, according to various embodiments.

FIGS. 16A and 16B show screenshots of an illustrative family chat conversation involving a family group that includes another family group.

### DETAILED DESCRIPTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

In many typical communications environments, users interact with communications services through a local network. For example, users within a home, office, enterprise branch location, etc. may interface with outside networks through routers and/or other network access systems. As voice, video, Internet, and other types of communications services converge, and as user network devices become increasingly portable, the network access systems are increasingly becoming hubs for substantially all user communications in proximity to the user's local network.

The increase in convergence and portability has provided many new types of user devices for interacting with communications services through the user's local network. However, there is typically little interactivity between the devices. As such, it may be difficult and/or inconvenient to use the devices in an integrative fashion, for example, to facilitate an integrated family or office environment.

Embodiments allow multiple user devices to be used in an integrative fashion to provide home management functionality, messaging functionality, videoconferencing functionality, cloud network interaction functionality, media sharing functionality, and/or other functionality. According to some embodiments, a supersystem is provided that includes at least one base station and at least two clients. Functionality of the supersystem and its component systems will be appreciated through various illustrative embodiments described herein.

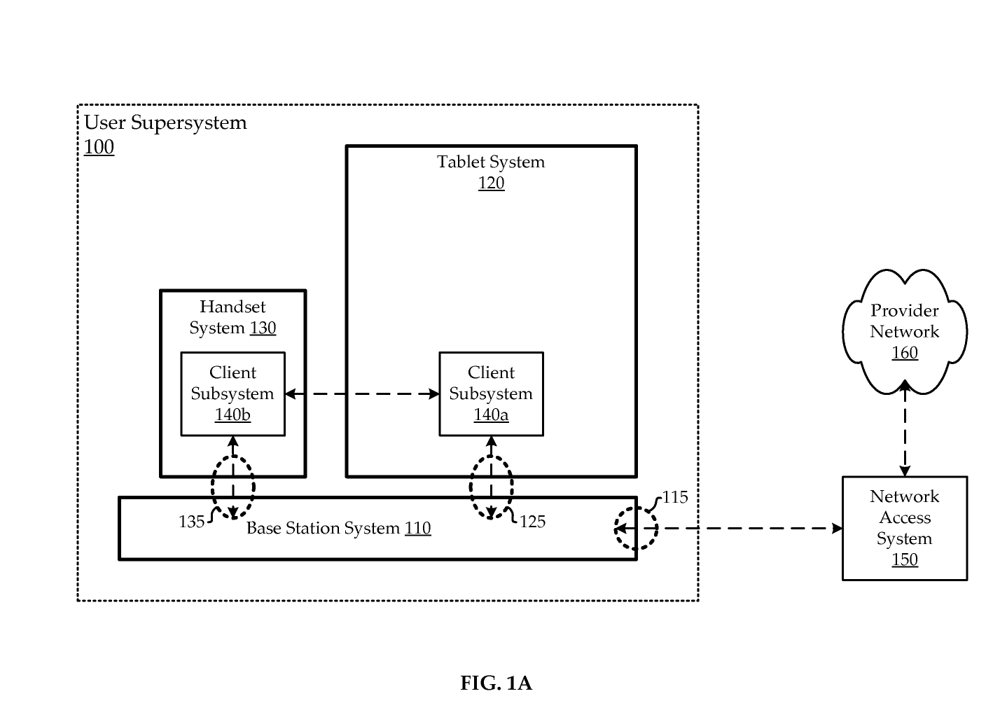

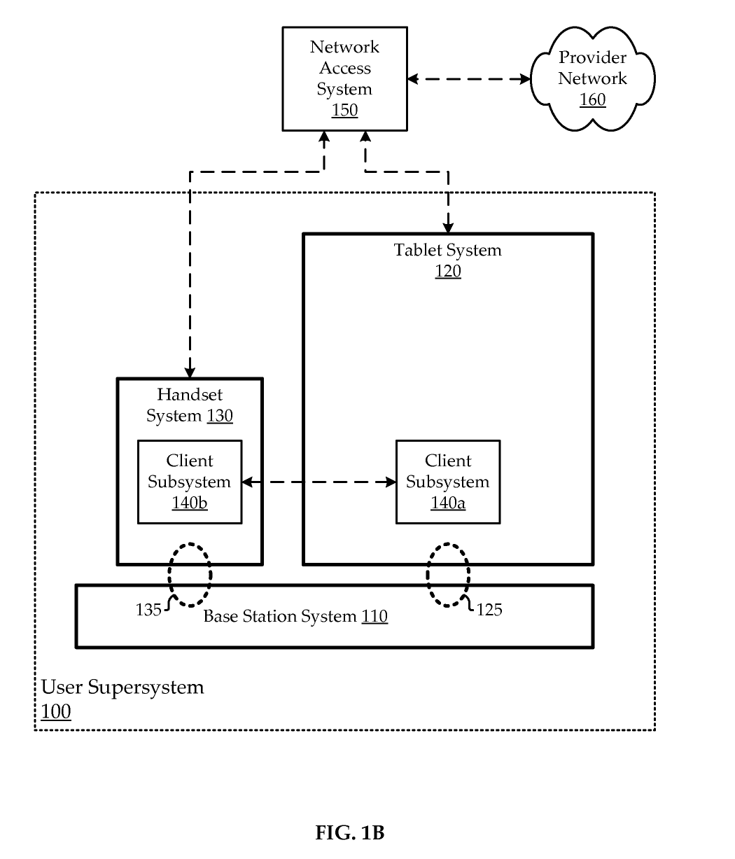

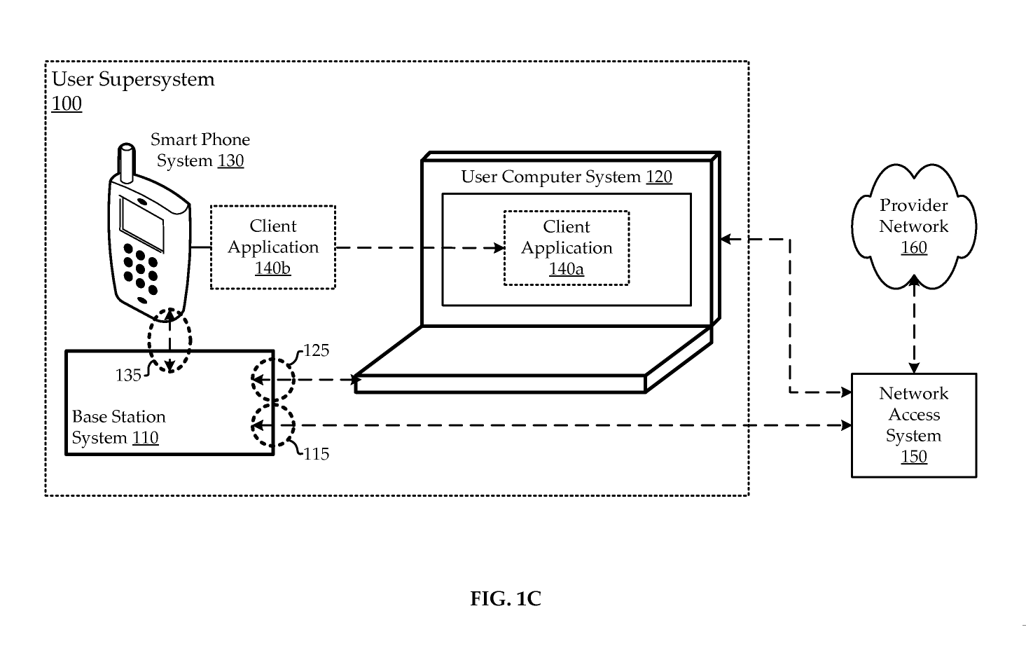

Turning first to FIG. 1A, a simplified block diagram is shown of an illustrative user supersystem 100 in communication with a provider network 160, according to various embodiments. The user supersystem 100 includes a base station system 110, a tablet system 120, and a handset system 130. Each of the tablet system 120 and the handset system 130 includes a client subsystem 140.

The user supersystem 100 interfaces with the provider network 160 via a network access system 150. As described more fully below, the network access system 150 may include a network interface device (NID), a router (e.g., a network address translation (NAT) router), and/or any other component used to provide subnet functionality. For example, because of the network access system 150, the user supersystem 100 may operate in the context of a local network. As used herein, “local network,” “user network,” “home network,” and similar phraseology is used broadly and interchangeably to include any type of subnet, like a local area network (LAN). It is understood that different types of local networks may be used in various embodiments without departing from the scope of the invention. For example, different local networks may operate using different protocols, different types of security, different architectures or topologies, etc.

In various embodiments, the tablet system 120, the handset system 130, and/or the base station system 110 are configured to provide interactive communications services to the client subsystems 140 within the local network. For example, the tablet system 120 and the handset system 130 may provide a user with communications functionality for interacting with a public network (e.g., the Internet), with the provider network 160 (e.g., for various provider services, like cloud storage and application serving), with other devices on the local network (e.g., computers, smart appliances, baby monitors, networked televisions, etc.), etc. Further, as described more fully below, the interactive communications functionality may include integrations between the tablet system 120 and the handset system 130 (e.g., application hand-offs and integrations, off-loading, etc.). The various features of the user supersystem 100 are implemented through its various component systems—the base station system 110, the tablet system 120, and the handset system 130. Each of these components systems will be described in turn.

Embodiments of the base station system 110 are configured with different types of functionality. In some embodiments, the base station system 110 is configured as a base for mounting one or both of the tablet system 120 and the handset system 130. For example, a tablet interface region 125 and a handset interface region 135 may be configured to physically receive a portion of the tablet system 120 and handset system 130, respectively (e.g., for docking) In another embodiment, the base station system 110 is configured as a special-purpose mount for interfacing the tablet system 120 and/or the handset system 130 with a fixture or other element (as an under-cabinet mount).

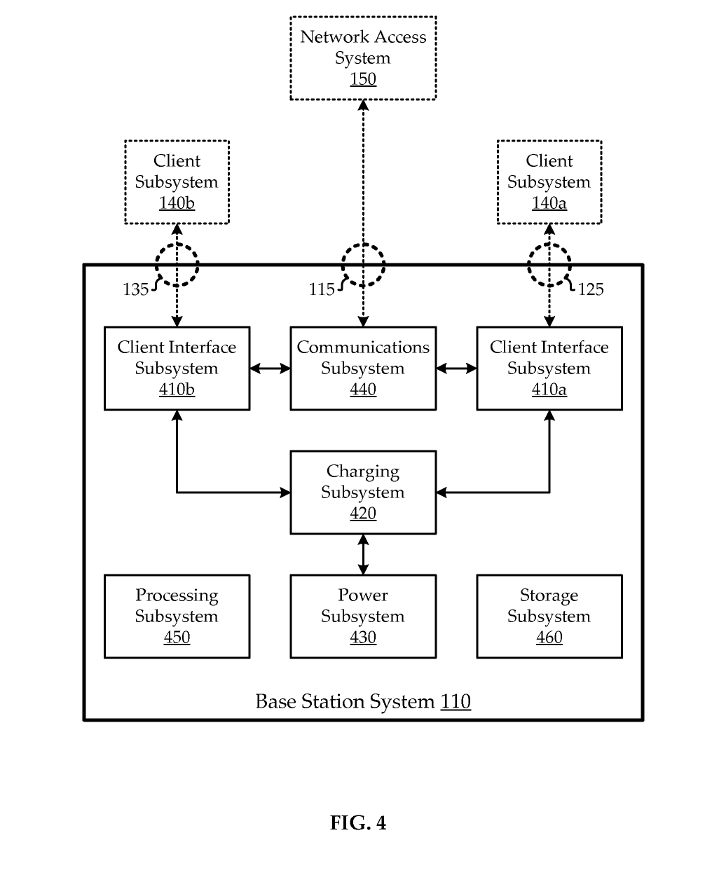

According to other embodiments, the base station system 110 includes charging functionality for charging the tablet system 120 and/or the handset system 130. For example, the charging may be contactless (e.g., by induction) or by physical ports and/or cables configured to interface with cables and/or ports on the respective tablet system 120 or handset system 130. According to still other embodiments, the base station system 110 includes communications functionality. Embodiments of the base station system 110 may be configured to provide the functionality of a wireless fidelity (WiFi) hotspot, a wireless repeater, a network hub, a network router (e.g., with or without network address translation (NAT) functionality), a picocell or femtocell, etc. For example, as shown, the base station system 110 may include a network interface region 115 for interfacing with the network access system 150. Certain embodiments may provide interactive communications between the provider network 160 (e.g., and/or other networks) and the client subsystems 140 (e.g., via the tablet interface region 125 and the handset interface region 135). These and other functions of the base station system 110 will be described more fully below (e.g., with reference to FIG. 4).

Other functionality of the user supersystem 100 is provided by the tablet system 120, the handset system 130, and/or their respective client subsystems 140. Embodiments of the tablet system 120 are typically implemented substantially as a tablet computing environment. The tablet system 120 may include a large display. The display may be active or passive; responsive to touch by a finger, stylus, or other implement; responsive to remote interactions, etc. Other interactivity may be provided by voice capture (e.g., audio-to-text translation, direct voice recording, etc.), by motion capture (e.g., gestures, etc.), and or in any other useful way.

In some embodiments, the tablet system 120 includes additional input/output components or features. Embodiments include a still and/or video capture device (e.g., a digital video camera), an integrated speaker, and/or ports (e.g., physical and/or logical) for interfacing with peripheral devices. For example, the tablet system 120 may be configured to interface with peripheral cameras, keyboards, printers, scanners, sensors, etc. In certain embodiments, the tablet system 120 interfaces with one or more peripherals via the base station system 110. For example, the base station system 110 may include a USB hub or a Bluetooth receiver, by which the tablet system 120 interfaces with a compatible keyboard.

In some embodiment, a digital video camera is integrated within the chassis of the tablet system 120, such that it can be pointed in various directions. In one embodiment, the camera swivels to point either in a direction substantially normal to the display (e.g., typically toward the primary user of the tablet system 120) or in an opposite direction (e.g., typically away from the primary user of the tablet system 120). Video captured by the camera may also be displayed substantially in real time on the display.

For example, suppose a first user employs the tablet system 120 to place a video call with a second user to show off a new home renovation. The first user may be able to see both the first user's camera input and the second user's camera input (e.g., as picture-in-picture, side-by-side, etc.) on the first user's display. By pointing the camera in a direction opposite the display and walking around the renovation with the tablet system 120, the first user may see both what the second user is seeing (i.e., the new renovation video capture) and the second user's reaction on the same display at the same time.

Embodiments of the handset system 130 provide various types of functionality, some similar to that of the tablet system 120. The handset system 130 may typically be implemented in a physical format similar to that of a cell phone, personal digital assistant (PDA), remote control, etc. (i.e., portable and ergonomic). The handset system 130 may be configured to receive user interactions through various types of controls. For example, some or all of the controls may be implemented as soft controls through a touch screen, additional controls may be implemented as hard buttons, etc. In certain embodiments, the handset system 130 includes a camera. In one embodiment, the camera is substantially identical to that of the tablet system 120. Of course, the handset system 130 may include additional components, such as microphones and speakers, ports and jacks, etc.

Notably, as described more fully below, embodiments of the tablet system 120 and the handset system 130 are designed and configured to provide an integrated experience. Using the example above, suppose a first user has employed the tablet system 120 to place a video call with a second user to show off a new home renovation. During the call, the first user decides that it would be more convenient to walk around with the handset system 130. The first user may pick up the handset system 130 and continue the call (e.g., substantially seamlessly hand off the video call from the tablet system 120 to the handset system 130). In one embodiment, the tablet system 120 and/or the handset system 130 may display a soft button (e.g., “send to handset”) to execute the hand-off. In another embodiment, removing the handset system 130 from the base station system 110 may automatically initiate the hand-off. In another embodiment, moving the handset system 130 out of direct proximity to the tablet system 120 (e.g., separating them by more than eighteen inches) may automatically initiate the hand-off.

While the tablet system 120 and the handset system 130 are described above with reference to certain hardware components (e.g., cameras, displays, etc.), it will be appreciated that much of the functionality of those systems is in fact implemented by their respective client subsystems 140. In various embodiments, each client subsystem 140 may be a “hard” client subsystem 140, a “soft” client subsystem 140, or some combination. For example, the client subsystem 140 may be implemented, in whole or in part, in hardware. Thus, it may include one or more Application Specific Integrated Circuits (ASICs) adapted to perform a subset of the applicable functions in hardware. Alternatively, the functions may be performed by one or more other processing units (or cores), on one or more integrated circuits (ICs). In other embodiments, other types of integrated circuits may be used (e.g., Structured/Platform ASICs, Field Programmable Gate Arrays (FPGAs), and other Semi-Custom ICs), which may be programmed. Each may also be implemented, in whole or in part, with instructions embodied in a computer-readable medium, formatted to be executed by one or more general or application specific controllers.

In some embodiments, as illustrated by the dashed line between client subsystems 140, there may be communications between the client subsystems 140. In some embodiments, the communications are direct between components of the client subsystems 140 themselves. In other embodiments, the communications are routed through components of the tablet system 120 and the handset system 130. In still other embodiments, the communications are routed through components of the base station system 110. And in other embodiments, the communications are routed through one or more other components of the local network, for example, the network access system 150.

It will be appreciated that many types of user supersystem 100 are possible with many types and/or numbers of component systems. For the sake of illustration, some of these alternate embodiments are described with reference to FIGS. 1B and 1C. For example, in some embodiments, the base station system 110 does not provide any communications functionality. FIG. 1B shows a simplified block diagram of another illustrative user supersystem 100 in communication with a provider network 160, where the base station system 110 provides little or no communications functionality, according to various embodiments.

As in FIG. 1A, the user supersystem 100 includes a base station system 110, a tablet system 120, and a handset system 130. Each of the tablet system 120 and the handset system 130 includes a client subsystem 140. In the embodiment of FIG. 1B, however, the network access system 150 is illustrated as being in direct communication with the tablet system 120 and the handset system 130, and not through the base station system 110. For example, each of the tablet system 120 and the handset system 130, and/or their respective client subsystems 140, may be configured to communicate directly with the local network (e.g., with the network access system 150.

It is worth noting that, where the base station system 110 does not provide communications functionality, there may be no need for a network interface region 115. Further, there may be no need to provide communications via the tablet interface region 125 or the handset interface region 135. For example, unlike in the embodiment of FIG. 1A, there may be no physical and/or logical (e.g., unwired) communications path between the base station system 110 and the tablet system 120 or the handset system 130 via the tablet interface region 125 or the handset interface region 135, respectively. Still, interface regions of the base station system 110 may provide various types of mounting functionality, charging functionality, etc., for example, as described above.

FIG. 1C shows a simplified block diagram of yet another illustrative user supersystem 100 in communication with a provider network 160, where the base station system 110 physically interfaces only with the tablet system 120, and where certain standard tablet system 120 and handset system 130 components are used, according to various embodiments. Again, as in FIG. 1A, the user supersystem 100 includes a base station system 110, a tablet system 120, and a handset system 130, and each of the tablet system 120 and the handset system 130 includes a client subsystem 140.

As illustrated, the tablet system 120 may be implemented as a standard (e.g., multi-purpose, undedicated) laptop or tablet computing environment, and the handset system 130 may be implemented as a standard smart phone environment. The client subsystems 140 are also shown as client applications. For example, some functionality of the client subsystem 140b shown as part of the handset system 130 of FIG. 1A may be implemented as an application running on a standard smart phone. In alternate embodiments, a dedicated handset system 130 (e.g., as shown in FIG. 1A) may be used with a standard tablet system 120 (e.g., as shown in FIG. 1C), or a standard handset system 130 (e.g., as shown in FIG. 1C) may be used with a dedicated tablet system 120 (e.g., as shown in FIG. 1A).

Other types of base station system 110 may be used as well, according to various embodiments. For example, as illustrated, the base station system 110 may be configured to physically interface with (e.g., provide docking for) the handset system 130 via a handset interface region 135, and to provide communications with the tablet system 120 via the tablet interface region 125 (e.g., by a wired or unwired communications path).

Further, the user supersystem 100 may interface with the local network in various ways. As illustrated, the base station system 110 is in communication with the network access system 150, the tablet system 120 is shown in communication both with the base station system 110 and with the network access system 150, and the handset system 130 is shown in communication only with the base station system 110. Of course, in alternate embodiments, the base station system 110 may not be in communication with the local network (e.g., as described with reference to FIG. 1B), the handset system 130 may have a direct communications path to the network access system 150, etc.

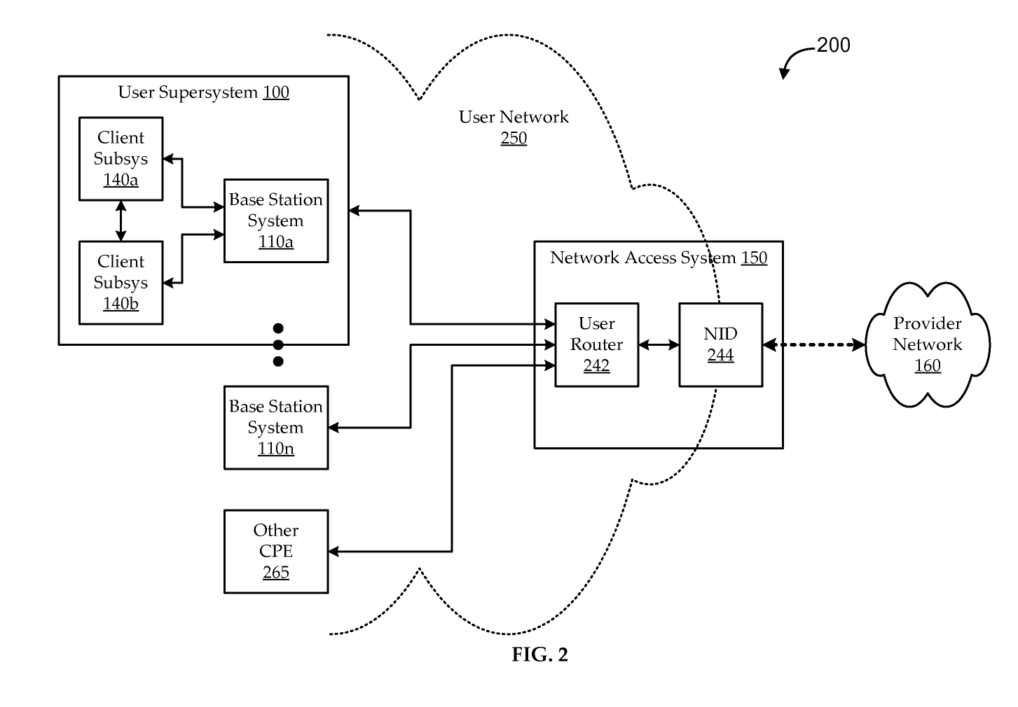

While each of the illustrative embodiments shown in FIGS. 1A-1C shows a single user supersystem 100 alone in its local network, user supersystems 100 may operate in the context of other devices in a local network. FIG. 2 shows a communications system 200 that includes a user network 250 having multiple clients, according to various embodiments. As illustrated, the user network 250 includes a user supersystem 100 and other devices in communication with a provider network 160 via a network access system 150.

It will be appreciated that many types of provider network 160 are possible. For example, the provider network 160 may include a cable, direct subscriber line (DSL), satellite, and/or other type of network topology. Further, different types of provider networks 160 may include different topologies or architectures between portions of the provider network 160 and between other networks, such as the Internet.

For example, according to one type of network topology, access networks from individual customers are aggregated in one or more locations within the provider network 160 (e.g., apartment access networks maybe aggregated at a building level, again at a neighborhood level, again at a service area level, etc.), with various aggregated regions being serviced by one or more main provider locations (e.g., central offices). At those or other locations, the provider network 160 may interface with other networks, for example, through various types of peering relationships, etc. Typically, non-customers may interface with customers in the provider network 160 through the public network.

As such, different types of network architectures and topologies may be used with various embodiments, such that different types of components may be required and/or desired at a user's premises to interface with an access portion of the provider network 160. For example, various types of receivers, ports, modems, etc. may be used at the user premises to interface the user's user network 250 with the provider network 160. The interface between the user network 250 and the provider network 160 may be implemented by components of the network access system 150.

In one embodiment, the network access system 150 includes a NID 244 and a user router 242. The NID 244 may include some or all of the components used to interface the user's access portion of the provider network 260 (e.g., the phone line, cable, fiber, etc. going to the user's home) with the user's premises. The NID 244 may be mounted internal or external to the user's premises (e.g., or some combination), and may include regions that are restricted to the user (e.g., accessible only to a service provider). In various embodiments, the NID 244 may provide various types of functionality, including network address translation, switching, routing, filtering, serving (e.g., using a micro-server), storage, cooling, monitoring, etc.

In embodiments where the NID 244 does not include a router or where additional routing is desired, the network access system 150 may further include the user router 242. The user router 242 may include a network address translator (NAT) router, a port address translation (PAT) device, a single-address NAT, a port-level multiplexed NAT, a static or dynamic NAT, a firewall, etc. The router may be particularly useful where multiple devices within the user network 250 are being used to communicate outside the user network 250, as in FIG. 2.

Regardless of the particulars of the provider network 160 and the network access system 150, the result may be manifest as a local user network 250. For example, the network access system 150 may include any components or functionality desired to provide services from the provider network 160 to the user network 250 and/or among the devices within the user network 250, such that the user network 250 operates as a subnet.

As illustrated, the user network 250 may include a user supersystem 100, an additional base station system 110n, and one or more other customer premises equipment (CPE) devices 265. For example, the CPE devices 265 may include computer systems (e.g., laptops, personal computers, tablet computers, etc.), television equipment (e.g., networked or Internet-enabled television sets, set-top boxes, etc.), smart phones, smart appliances (e.g., networked lighting, refrigerators, water heaters, etc.), sensor equipment (e.g., smoke or radon alarms, thermostats, baby monitors, etc.), etc. Of course, any other types or numbers of devices or systems may be included in the user network 250. Each of these devices or systems may be in direct or indirect communication with the network access system 150 (e.g., via the user router 242).

Multiple base station systems 110 may be used in a topology, like the one illustrated in FIG. 2, to provide certain enhanced functionality. As described above, the base station systems 110 may be configured to provide certain types of communications functionality. For example, the base station systems 110 may act as Wi-Fi hotspots or repeaters. When there are multiple base station systems 110 in the user network 250, the client subsystems 140 may be configured to interface with the base station system 110 having the strongest signal (e.g., or the closest base station system 110, the base station system 110 having certain functionality, etc.).

It will be appreciated that these and/or other techniques may be used to provide a substantially ubiquitous unwired connectivity experience throughout the user's premises. Notably, changes in signal integrity may affect apparent latency, error rates, bandwidth, and/or other connectivity conditions. For example, as a home user moves between room or floors, and even external to the home within some range, it may be desirable for the user to experience a substantially consistent connectivity experience.

For example, the user supersystem 100 is illustrated as including two client subsystems 140 in communication with each other and with a first base station system 110a. If one or both of the client subsystems 140 is moved out of operational range of the first base station system 110a and into operational range of a second base station system 110n, the one or both client subsystems 140 may automatically switch to being in communication with the second base station system 110n. Accordingly, the user supersystem 100 definition may dynamically update to capture changes in topology.

For the sake of illustration, a customer calls a fabric seller to inquire about a particular fabric. A video session is initiated, beginning with the fabric seller sitting at her desk in front of the tablet system 120 of her user supersystem 100 (e.g., acting as a first client subsystem 140a). She desires to show the customer the requested fabric, while also illustrating the breadth of her fabric stock and the attractiveness of her storefront to entice the customer to visit in person. To this end, she seamlessly hands the video session off to her handset system 130 (e.g., acting as a second client subsystem 140b) and virtually walks the customer (i.e., via real-time video capture) through the store to the location of the requested fabric, all the while remotely watching the customer's reaction on the handset system 130 display. The requested fabric is located on the second floor of the store, far from the base station system 110 (e.g., which may be collocated with the tablet system 120). However, the fabric seller has an additional base station system 110 configured as a repeater on the second floor for boosting the signal in that area of the store (e.g., for when the handset system 130 is in proximity). As such, she is able to maintain a high quality, real-time video stream with her customer throughout the communications session.

It will be appreciated that other types of integrations are possible in a user network 250, like the one illustrated in FIG. 2. For example, as described above, the client subsystems 140 may interact and/or be integrated with each other. Further, in certain embodiments, the client subsystems 140 may be configured to interface with one or more other CPE devices 265. For example, the tablet system 120 may be configured to display a monitor of current energy use by smart appliances in the home, to remotely control lights and/or other devices in the home, to monitor a closed caption video feed (e.g., from a security system), etc. These types of integrations may be implemented by direct communication links, through one or more base station systems 110, through components of the network access system 150, through other devices in the user network 250, etc.

Of course, it may be desirable for devices or systems in one user network 250 to interface with devices or systems in another user network 250. Each of the illustrative embodiments shown in FIGS. 1A-1C shows only a single user supersystem 100, and the embodiment of FIG. 2 shows only a single user network 250. However, user supersystems 100 may typically operate in the context of a larger communications system having multiple users with multiple user networks 250, each having multiple devices and systems.

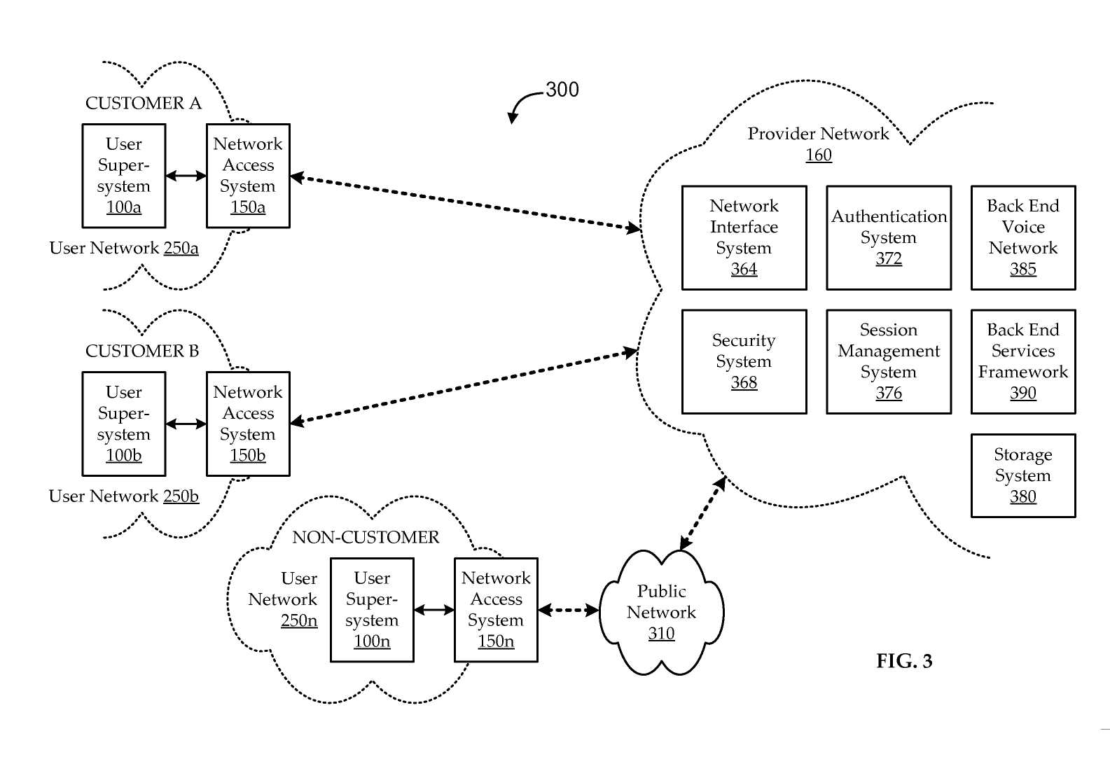

FIG. 3 shows a communications system 300 that includes multiple user networks 250, according to various embodiments. As illustrated, the user network 250 includes a user supersystem 100 in communication with a common provider network 160 via a network access system 150. Notably, a first user network 250a is associated with a first customer (“Customer A”) of the service provider associated with the provider network 160, a second user network 250b is associated with a second customer (“Customer B”) of the service provider, and a third user network 250c is associated with a user that is not a customer of the service provider (“Non-Customer”).

As described above, in some network topologies, customers may be in substantially direct communication with the provider network 160, while non-customers may have access to the provider network 160 only through the public network 310 (e.g., the Internet). In certain embodiments, the communications to and from the respective network access systems 150 are substantially the same, regardless of whether the user network 250 is associated with a customer. In other embodiments, certain additional or alternate functionality is available to customers. For example, when the service provider has less or no control over the access network to a user (e.g., for non-customers), provision of certain services may be difficult, impractical, or impossible (e.g., provision of certain services may be to slow, too costly, etc. when offered through the public network). In still other embodiments, various types of relationships (e.g., peering relationships, content delivery or mirroring relationships, etc.) may be used to provide similar services to both customers and non-customers.

Typically, services are provided by the service provider from the provider network 160. As illustrated, the provider network 160 may be described in terms of a number of functional blocks. For example, the provider network 160 may include a network interface system 364, a security system 368, an authentication system 372, a session management system 376, a storage system 380, a back-end voice network 385, and a back-end services framework 390. Notably, these functional blocks may, in fact, be collocated or distributed, implemented in one or more components or systems, implemented in hardware or software, etc., according to various embodiments. As such, descriptions of functionality of the provider network 160 in this context is intended to add clarity to the description and should not be construed as limiting the scope of embodiments.

In some embodiments, communications to and from various user networks 250 (e.g., via their respective network access systems 150) interface with the provider network 160 at the network interface system 364. Embodiments of the network interface system 364 may include any type of components, subsystems, etc. for interfacing with the user access networks, with the public network 310, and/or with additional networks (e.g., content delivery networks (CDNs), back-haul networks, peer networks, proprietary networks, etc.). For example, the network interface system 364 may include and handle various ports and connections, implement signal processing functions (e.g., modulations and demodulations), implement protocol handling, etc.

In some embodiments, communications are further handled by the security system 368. For example, it may be desirable for functionality of the network interface system 364 to be enhanced with logical security (e.g., firewalls, encryption, etc.) and/or with physical security (e.g., locked servers, etc.). Notably, functionality of the security system 368 may be further applied to other systems of the provider network 160. For example, physical and/or logical security may be applied to some or all of the authentication system 372, storage system 380, etc.

In addition to the types of security provided by the security system 368, other types of user (e.g., or device, system, network, etc.) authentication may be desired. Embodiments of the authentication system 372 are used for authorization, authentication, accounting, registration, and/or other similar functionality. For example, the authentication system 372 may include functionality of an “Authentication, Authorization, and Accounting” (AAA) server, a “Remote Authentication Dial In User Service” (RADIUS), etc. In one embodiment, the network interface system 364 implements a Network Access Server (NAS) in communication with a RADIUS server implemented by the authentication system 372.

In other embodiments, the authentication system 372 may be used to perform other types of authentication and registration. In one embodiment, new devices in a user network 250 may send a registration request to the authentication system 372, which may keep track of and/or authorize user devices. In another embodiment, individual communications sessions are authorized, registered, etc. by the authentication system 372. In still another embodiment, the authentication system 372 handles authentication credentials of non-customers (e.g., using cookies, etc.), content providers, etc. In yet other embodiments, the authentication system 372 handles additional accounting functions, such as usage tracking against fair access policies (FAPs), etc.

As discussed above, embodiments of the user supersystems 100 provide interactive communications functionality via client subsystems 140. In some embodiments, certain functionality is provided in the context of communication sessions. For example, session streams may be used to manage large numbers of simultaneous communications transactions occurring over the communications network 300 (e.g., chat sessions, voice or video calls, messaging, content delivery, etc.). In some embodiments, these session streams are handled by the session management system 376.

Embodiments of the session management system 376 may manage session in various ways, depending on the type of session. For example, certain embodiments may manage and/or contribute to classifications of service flows as unicast, multicast, broadcast, simulcast, etc. As such, the session management system 376 may be configured to assign and manage session identifiers, handle session persistence, handle session protocol usage, etc. In some embodiments, the session management system 376 implements the Session Initiation Protocol (SIP) for some or all of the session streams. For example, SIP may be used by the session management system 376 as a signaling protocol, for handling multi-user communications, including streaming media, voice or video calls (e.g., voice over Internet protocol (VoIP) calls), instant messaging, real-time gaming, etc.

It will be appreciated that the network interface system 364, security system 368, authentication system 372, session management system 376, and/or other functional blocks of the provider network 160 may effectively provide various front-end types of functionality. For example, services delivered to the users may be provided by back-end systems, other content sources, etc. The front-end functional blocks described my, thus, effectively mediate provision of those services to users via their respective client subsystems 140.

As illustrated, back-end functionality may be provided by the back-end voice network 385, the back-end services framework 390, and the storage system 380. For example, voice calls and certain data flows may be handled by the back-end voice network 385. Embodiments of the back-end voice network 385 may include the plain old telephone service (POTS) network and/or other voice networks, such as packet-switched networks (e.g., via fiber-optic networks, DSL networks, etc.).

Embodiments of the back-end services framework 390 include and/or interface with all other service provision of the provider network 160. In some embodiments, the back-end services framework 390 provides integrated messaging functionality. For example, different types of messaging capabilities may be provided between user supersystems 100, between different client subsystems 140, from a user supersystem 100 to other user devices inside or outside of the user network 250, etc. The messaging functionality may include e-mail messaging, Short Message Service (SMS) messaging, video messaging, etc.

The back-end services framework 390 may also provide various cloud computing and/or content serving functionality. For example, in certain embodiments, the storage system 380 includes a storage area network (SAN) within the provider network 160. In other embodiments, the storage system 380 includes, or is in communication with, data storage (e.g., servers) over external networks. For example, the storage system 380 may include third-party storage offered over the Internet. The back-end services framework 390 may use the storage system 380 to provide functionality, including, for example, content mirroring, application serving, and cloud-based address books, photo albums, calendars, etc.

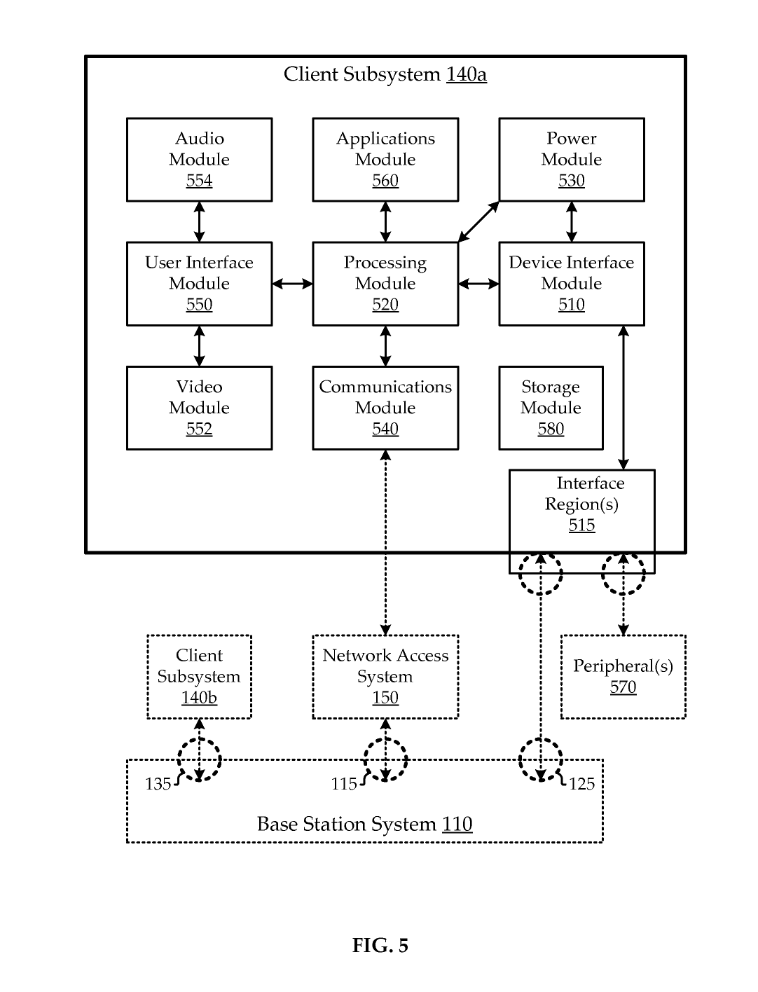

It will be appreciated that other functionality may be provided by embodiments of the back-end services framework 390 and/or other components of the provider network 160. Of course, much of the functionality described with reference to components of the provider network 160 may related to (e.g., rely on, be further integrated with, be enhanced by, etc.) components of the user supersystem 100. For the sake of additional clarity, embodiments of some functional components of illustrative base station systems 110 and client subsystems 140 are described with reference to FIGS. 4 and 5, respectively.

FIG. 4 shows a functional block diagram of a base station system 110 in the context of certain other devices and systems, according to various embodiments. For example, embodiments of the base station system 110 may be implemented substantially as described with reference to FIG. 1A. For the sake of clarity and to add context to the description, the base station system 110 is shown in communication with a first client subsystem 140a, a second client subsystem 140b, and a network access system 150 via a tablet interface region 125, a handset interface region 135, and a network interface region 115, respectively. It will be appreciated from the descriptions above that many other arrangements are possible according to other embodiments. As such, the context should not be construed as limiting the scope of the embodiments.

Many functions of embodiments of the base station system 110 are provided by various functional blocks. As illustrated the functional blocks may include one or more client interface subsystems 410, a charging subsystem 420, a power subsystem 430, a communications subsystem 440, a processing subsystem 450, and a storage subsystem 560. For example, embodiments of the client interface subsystems 410 are configured to interface with one or more of the client subsystems 140, physically and/or logically.

In some embodiments, the client interface subsystems 410 of the base station system 110 include physical features for mounting one or both of the tablet system 120 and the handset system 130. For example, the client interface subsystems 410 include the tablet interface region 125 and handset interface region 135, configured to physically receive a portion of the tablet system 120 and handset system 130, respectively. In one embodiment, the physical receiving is used to provide docking functionality for one or more client subsystems 140.

In other embodiments, the client interface subsystems 410 include mounting features designed to removably couple the base station system 110 with the tablet system 120, for example, so that the otherwise portable tablet system 120 remains in place for certain uses. As one example, the tablet system 120 includes a touch screen for use in typing, drawing, dragging, and/or other types of user interactivity. Using the base station system 110 to secure the tablet system 120 while typing, etc. may improve the user experience.

In still other embodiments, the client interface subsystems 410 include feature that configure the base station system 110 as a special-purpose mount for interfacing the tablet system 120 and/or the handset system 130 with a fixture or other element. For example, embodiments of the base station system 110 may provide under-cabinet mounting functionality for use in a kitchen, so that the tablet system 120 can be swung down from under the kitchen cabinets when in use and swung out of the way otherwise.

In even other embodiments, the client interface subsystems 410 provide support for functionality of other components. For example, charging functionality of the charging subsystem 420 and/or communications functionality of the communications subsystem 440 may be implemented in part through features of the client interface subsystems 410.

Embodiments of the base station system 110 include the charging subsystem 420, configured to provide charging functionality for charging one or more client subsystems 140 or their associated devices (e.g., the tablet system 120 and/or the handset system 130 of FIG. 1A). In certain embodiments, the charging is contactless (e.g., by induction). In certain other embodiments, the charging functionality is provided by physical ports and/or cables configured to interface with cables and/or ports on the respective devices (e.g., the tablet system 120, handset system 130, etc.). These charging functions may use features of the client interface subsystems 410.

For example, in one embodiment, a handset system 130 in which one client subsystem 140b is implemented includes two conductive contacts and a magnetic element in proximity to the bottom of its chassis. The corresponding client interface subsystem 410b of the base station system 110 similarly includes two conductive contacts and a magnetic element as part of the handset interface region 135. When the handset system 130 is coupled with the base station system 110, the magnetic elements hold the handset system 130 in place while the conductive contacts facilitate the flow of charging current to the handset system 130, as managed by the charging subsystem 420. In some embodiments, the charging functionality of the charging subsystem 420 is enhanced in one or more ways. For example, the base station system 110 may provide functionality for charge monitoring, error detection, battery failure, quick charging, etc.

Of course, embodiments of the charging subsystem 420 may require a source of power from which to provide charging current. In some embodiments, the charging subsystem 420 is coupled with the power subsystem 430. Some embodiments of the power subsystem 430 may simply provide an interface between the base station system 110 and a power source (e.g., a wall outlet). Other embodiments of the power subsystem 430 include additional functionality. For example, the power subsystem 430 may process (e.g., clean, convert, regulate, step up or step down, etc.) the input power, monitor and/or regulate power consumption of the base station system 110 and/or other devices, provide different levels for different functions (e.g., provide constant output current to the charging subsystem 420, low-voltage output to internal circuitry of the base station system 110, regulated power to a cooling fan, etc.), etc.

As described above, some embodiments of the base station system 110 include the communications subsystem 440 for providing certain communications functionality. In various embodiments, the base station system 110 is configured (using functionality of the communications subsystem 440) to act as a wireless fidelity (Wi-Fi) hotspot, a wireless repeater, a network hub, a network router (e.g., with or without network address translation (NAT) functionality), a picocell or femtocell, etc. For example, as shown, the communications subsystem 440 may include the network interface region 115 for interfacing with the network access system 150.

In one embodiment, the network interface region 115 includes a physical port for plugging into a network (e.g., an Ethernet port). In another embodiment, the network interface region 115 includes an unwired (e.g., wireless, cellular, etc.) receiver for interfacing with a local network via the network access system 150. The network interface region 115 may also include one or more logical ports, antennae, and/or any other useful network interface component. In certain embodiments, the network access system 150 is implemented within a chassis of the base station system 110, such that connections with the network access system 150 are internal to the base station system 110, and may or may not include physical connections (e.g., the connections may be logical or functional connections between functional components or modules).

Certain embodiments of the communications subsystem 440 provide interactive communications functionality (e.g., from other devices, the user network, the provider network, and/or other networks) to the client subsystems 140. For example, the communications subsystem 440 may be coupled with the client interface subsystems 410 such that communications services may be provided via the tablet interface region 125 and the handset interface region 135. Alternately, the communications subsystem 440 may include additional transceivers, logical ports, etc. For example, embodiments of the communications subsystem 440 may include Bluetooth communications components, USB hubs, radio antennae, etc.

In various embodiments of the base station system 110, functionality of the various functional blocks is supported by one or more of the processing subsystem 450 and the storage subsystem 460. For example, embodiments of the processing subsystem 450 include a central processing unit and/or dedicated processors (e.g., communications processors, graphics processors, etc.). Embodiments of the storage subsystem 460 may include a hard disk drive, a flash drive, a micro server, a data processing engine, and/or any other useful storage and/or data management components.

It will be appreciated that various embodiments of the base station system 110 may include only some of the functional blocks shown in FIG. 4 and, accordingly, only some of the functionality described above. Further, in some embodiments, the functionality of the base station system 110 is integrated into a single chassis. In other embodiments, certain functionality may be offloaded to peripheral devices (e.g., a USB storage drive as part of the storage subsystem 460, or an external signal booster as part of the communications subsystem 440) or distributed among multiple components. In still other embodiments, the chassis of the base station system 110 includes additional or alternate features. For example, the chassis may include various device interfaces (e.g., recesses, locks, ports, plugs, etc.), controls (e.g., buttons, switches, etc.), physical features (e.g., cooling fins, rubberized feet, etc.), etc.

It will be further appreciated that much of the functionality described above with reference to the base station system 110, and additional functionality of embodiments of user supersystems 100, may be implemented by the client subsystems 140. FIG. 5 shows a functional block diagram of a client subsystem 140a in the context of certain other devices and systems, according to various embodiments. For example, embodiments of the client subsystem 140a may be implemented substantially as described with reference to FIG. 1A. For the sake of clarity and to add context to the description, the client subsystem 140a is shown in communication with a network access system 150, a base station system 110 and one or more peripheral devices 570. The base station system 110 is shown in communication with the client subsystem 140a, another client subsystem 140b, and the network access system 150, via a tablet interface region 125, a handset interface region 135, and a network interface region 115, respectively.

It will be appreciated from the descriptions above that many other arrangements are possible according to other embodiments. As such, the context should not be construed as limiting the scope of the embodiments. For example, while the description will focus on client subsystem 140a, the same or different functional blocks may be included in client subsystem 140b. Notably, the client subsystem 140a is intended to broadly show illustrative functionality of a client subsystem 140, whether part of a dedicated device system (e.g., like the tablet system 120 or the handset system 130 of FIG. 1A), part of an undedicated device system (e.g., like the tablet system 120 or the handset system 130 of FIG. 1C), etc.

Embodiments of the client subsystem 140a may implement various functionality through functional blocks. As illustrated, the functional blocks may include a device interface module 510, one or more interface regions 515, a processing module 520, a power module 530, a communications module 540, a user interface module 550, a video module 552, an audio module 554, an applications module 560, and a storage module 580. As described above, embodiments of the client subsystem 140a may be incorporated within a device chassis.

Embodiments of the device interface module 510 are configured to provide an interface between the client subsystem 140 (e.g., or its respective device chassis) and either the base station system 110, a peripheral device 570, or some other device or component. For example, embodiments of the device interface module 510 may functionally correspond to embodiments of a client interface subsystem 410 of a base station system 110, as described with reference to FIG. 4.

In some embodiments, the device interface module 510 may be coupled with interface regions 515 that provide physical and/or logical components or features to support certain types of interfaces. For example, the interface regions 515 may include metal contacts (e.g., to facilitate charging from the base station system 110), a headphone or headset jack (e.g., for audio input/output), various internal ports or slots (e.g., for a battery, a memory card, a Subscriber Identity Module (SIM) card, etc.), etc. In one embodiment, the interface regions 515 include features for interfacing directly with the base station system 110 (e.g., via the tablet interface region 125 or the handset interface region 135). In another embodiment, the interface regions 515 include features for interfacing between the client subsystem 140a and another client subsystem 140 (e.g., between a handset system 130 and a tablet system 120). In yet another embodiment, the interface regions 515 are configured to support functionality of the communications module 540, as described more below.

Embodiments of the client subsystem 140a include a processing module 520. The processing module 520 may include a central processor, a graphics processor, an audio processor, and/or any other useful dedicated or multi-purpose processing components. For example, embodiments of the processing module 520 are designed to support functionality of other functional modules of the client subsystem 140a.

In some embodiments, the client subsystem 140a includes a power module 530. Embodiments of the power module 530 may deliver power to other functional modules, manage power consumption, process (e.g., clean, regulate, etc.) power, etc. Other functionality of the power module 530 may be appreciated in the context of other types of functionality. For example, if an external active device is being used, the device may draw power from the client subsystem 140a, and that power delivery may be controlled by the power module 530. In another example, during a charging or discharging cycle of a battery, the power module 530 may control and/or monitor charging or discharging current.

Other embodiments of the client subsystem 140a include a communications module 540. Embodiments of the communications module 540 provide various types of communications functionality. For example, as illustrated, the communications module 540 may handle communications with the base station system 110 and/or the network access system 150. In some embodiments, the communications module 540 performs a number of client-side functions, such as handling of requests, messaging, communications sessions, proxy functions, etc. In certain embodiments, the communications module 540 uses functionality of the device interface module 510 and/or other functional modules, for example, to manage certain types of communication flows with certain types of other devices or systems (e.g., for protocol management, demodulation, etc.).

Still other embodiments of the client subsystem 140a include a user interface module 550. In some embodiments, the user interface module 550 handles inputs and outputs through the video module 552, the audio module 554, and/or the peripheral devices 570. For example, embodiments of the video module 552 include a camera and a display. The display may be active or passive; responsive to touch by a finger, stylus, or other implement; responsive to remote interactions, etc.

Embodiments of the camera include a digital video camera integrated within the chassis of the client subsystem 140a, such that it can be pointed in various directions. In one embodiment, the camera swivels to point either in a direction substantially normal to the display (e.g., typically toward the primary user of the tablet system 120) or in an opposite direction (e.g., typically away from the primary user of the tablet system 120). Video captured by the camera may also be displayed substantially in real time on the display. The camera may also be configured to take still images.

Embodiments of the audio module 554 may include audio input components (e.g., microphones) and audio output devices (e.g., speakers). Input and/or output functionality of the user interface module 550 may be further implemented through peripheral devices, such as peripheral cameras, keyboards, printers, scanners, sensors, etc. In certain embodiments, the client subsystem 140a is configured to interface with one or more input/output devices via the base station system 110. For example, the base station system 110 may include a USB hub or a Bluetooth receiver, by which the client subsystem 140a interfaces with a compatible keyboard. Other interactivity may also be provided by voice capture (e.g., audio-to-text translation, direct voice recording, etc.) through the audio module 554, by motion capture (e.g., gestures, etc.) through the video module 552, and/or in any other useful way.

It will be appreciated that much of the functionality of the various modules described above may be designed substantially to support delivery of certain applications to a user of the client subsystem 140a. Embodiments of the client subsystem 140a include an applications module 560 for handling applications through the client subsystem 140a. In various embodiments, the applications module 560 uses functionality of other modules, such as the user interface module 550, the processing module 520, and the communications module 540 to implement applications functions.

Applications delivery by the applications module 560 and/or other types of functionality of the client subsystem 140a may be further supported by local storage through the storage module 580. Embodiments of the storage module 580 may include disk drives, flash drives, and/or other data storage and processing components. In certain embodiments, the storage module 580 is configured to integrate functionally with external storage, for example, in the base station system 110 or in the “cloud” (e.g., offered via the Internet, the provider network, etc.).

It will be appreciated that, while many embodiments are described above with reference to a user supersystem 100 having two client subsystems 140 (e.g., in a tablet system 120 and a handheld system 130), other configurations and topologies are possible. In some embodiments, the user supersystem 100 includes one tablet system 120 and multiple handheld systems 130, for example, used throughout a home. In other embodiments, multiple tablet systems 120 are used as part of the user supersystem 100. In still other embodiments, other devices (e.g., in the home) include some or all of the functionality of the client subsystem 140 for operation as part of the user supersystem 100. For example, a client subsystem 140 may be implemented as part of an alarm clock, weather station, television set-top box, laptop computer, etc.

It will further be appreciated that various embodiments of client subsystems 140 may include only some of the functional blocks (or additional functional blocks to those) shown in FIG. 5. Accordingly, other embodiments may include only some of the functionality described above or different functionality from that described above. Further, it will be appreciated that some or all of the functionality of the client subsystems 140, and also some or all of the functionality of the base station system 110, may be implemented by a computational system. For example, dedicated and/or multi-purpose hardware and/or software may be used to implement many of the functions described with reference to FIGS. 4 and 5.

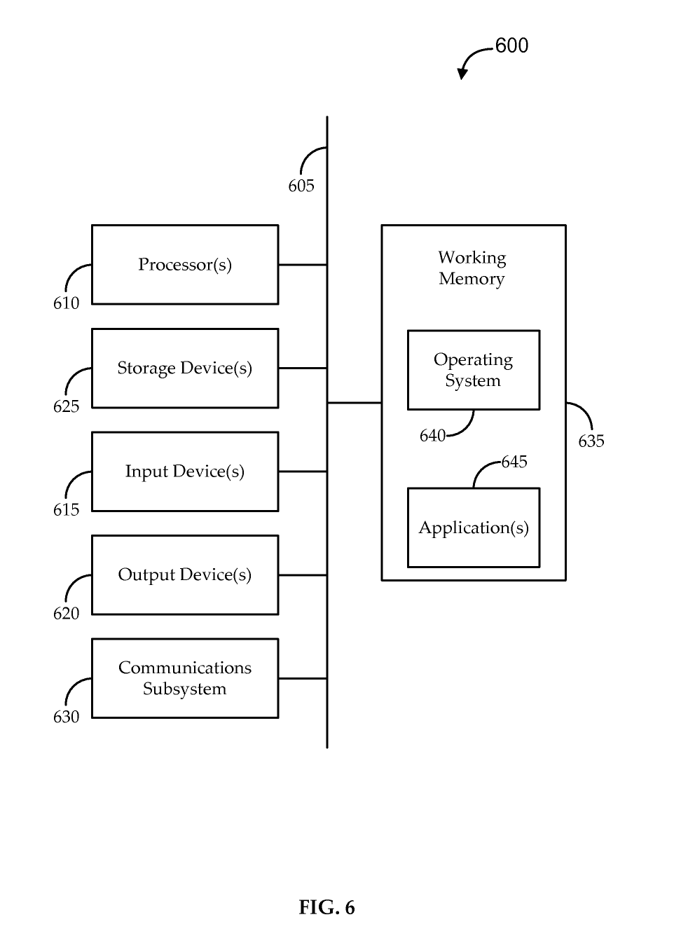

FIG. 6 shows a simplified block diagram of an illustrative computational system 600 for use in implementing components of various embodiments. For example, components of the computational system 800 may be used to implement functionality of the base station system 110 or the client subsystem 140 (e.g., or the associated tablet system 120 or handset system 130). It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computational system 600 is shown to include hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 602.11 device, a WiFi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs the computational system 600 to perform methods of the invention. According to a set of embodiments, some or all of the procedures of such methods are performed by the computational system 600 in response to processor 610 executing one or more sequences of one or more instructions (which might be incorporated into the operating system 640 and/or other code, such as an application program 645) contained in the working memory 635. Such instructions may be read into the working memory 635 from another machine-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer readable medium”, as used herein, refer to any medium that participates in providing data that causes a machine to operate in a specific fashion. In an embodiment implemented using the computational system 600, various machine-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 625. Volatile media includes, without limitation, dynamic memory, such as the working memory 635. Transmission media includes coaxial cables, copper wire and fiber optics, including the wires that comprise the bus 605, as well as the various components of the communication subsystem 630 (and/or the media by which the communications subsystem 630 provides communication with other devices).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computational system 600. The communications subsystem 630 (and/or components thereof) generally will receive the signals, and the bus 605 then might carry the signals (and/or the data, instructions, etc., carried by the signals) to the working memory 635, from which the processor(s) 610 retrieves and executes the instructions. The instructions received by the working memory 635 may optionally be stored on a storage device 625 either before or after execution by the processor(s) 610.

### Integrated Multi-Modal Chat Embodiments

It will be appreciated from the above description that the systems, devices, and methods described above may be used to facilitate many different types of functionality. One type of functionality involves using the user supersystem 100 as a communications hub to facilitate context-driven, multi-modal communications. For example, the tablet system 120 may be used as a graphical communications hub in a family's home, used by the family to communicate to and from the home via multiple communications modes (e.g., family chat, family activities, user-based messaging, etc.) driven by the desired context of the communications.

Many types of communications modes are known, and many devices are available to consumers for communicating using one or more of these various modes. Typically, communications are channel-driven, rather than context-driven. For example, the selected device and communications mode may drive the type of conversation (e.g., voice calls, video calls, Short Message Service (SMS), Multimedia Messaging Service (MMS), etc.), rather than the context of the conversation driving the communications mode. While channel-driven communications may often provide access to a rich set of features (e.g., options, configurations, etc.), they may also be less intuitive and less integrative.

Embodiments provide context-driven communications modes for use in facilitating family communications via a communications hub in the home and at least one other communications device. As used herein, “family” is intended generally to describe any relatively small group of parties (e.g., individuals, groups, entities, etc.) that tend to share a space and tend to communicate frequently about issues, including issues affecting the shared space. Similarly, the term “home,” as used herein, generally describes the shared space of the “family.”

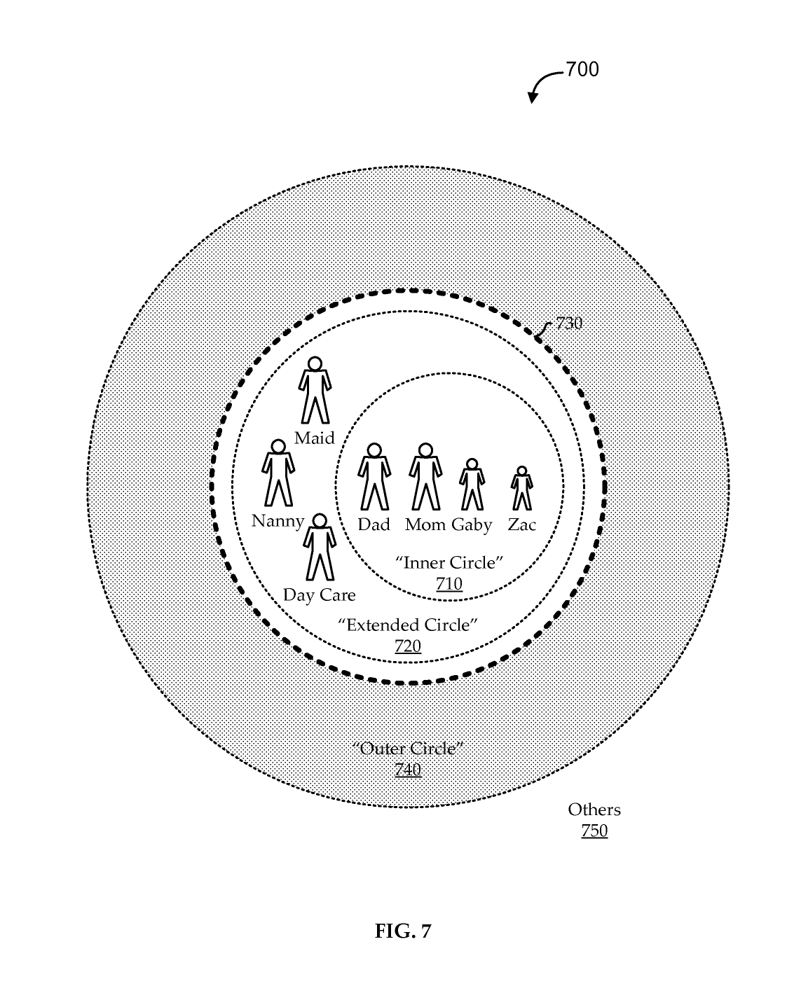

For the sake of clarity, FIG. 7 illustrates an embodiment of a family communications environment 700. In various embodiments, the family communications environment 700 includes one or more levels of family communications hierarchy. For example, as shown, the family communications environment 700 may include an “inner circle” 710, an “extended circle” 720, an “outer circle” 740, and “others” 750. These designations are used herein as some of the contextual factors that may be used in driving a communications mode determination.

Typically, certain levels of the family communications hierarchy are considered to be “in the home,” while others are considered to be “outside the home.” These phrases are intended generally to refer to a party's relationship with the household, rather than with their actual location at any given point in time. An illustrative boundary between “outside the home” and “in the home” parties is shown as dashed region boundary 730.

For example, while it is not expected that any of the family members will spend all their time inside the home premises (e.g., or even a significant amount of time there), members of the family that live in the home and/or are directly impacted by home-related or family-related issues may be considered to be “in the home.” These parties may be considered “in the home” family members, even when they are not, at a particular moment, physically inside or near the home. These “in the home” family members may, of course, communicate with many other parties, who may be considered “outside the home.”

In one embodiment, the “family” is considered to include immediate family members living together in a single “home” (e.g., a house, apartment, etc.). As illustrated, this may include only the “inner circle” 710 of “Dad,” “Mom,” “Gaby,” and “Zac.” For example, the “inner circle” 710 may represent the group of parties typically affected by, and possibly participating in, family conversations.

In another embodiment, the family “inner circle” 710 is considered to include others. For example, it may be desirable to further include people who frequent the “home” into the “inner circle” 710 family conversations, like a nanny or caregiver, close relative or friend, maid, etc. Alternatively, it may be desirable to include certain parties in all family conversations as part of the “inner circle” 710, while including others in only a subset of those conversations as part of the “extended circle” 720. In some embodiments, “inner circle” 710 conversations and “extended circle” 720 conversations can separately be initiated, depending on the context of the conversation.

Notably, various types of conversations among family members (e.g., “inner circle” 710 and/or “extended circle” 720 members) may involve a communications hub in the home (e.g., the user supersystem 100) and one or more other devices. These other devices may include mobile devices, which may be located in or out of the home at any particular time. For example, some or all of the family members share the user subsystem 100 while at home, and some or all of the family members may also have individual devices, like cell phones, personal digital assistants (PDAs), etc. In some cases, each of the various devices may send and/or receive messages over different communications channels (e.g., communications networks, protocols, formats, etc.).

In a first example, suppose Mom is bringing home dinner. It may be desirable to readily share that information with everyone in the “inner circle” 710, regardless of the respective communications channels used to reach the intended recipients. In a second example, suppose Zac woke up with a cold, and Mom wants to make that known to everyone who may be affected. It may be desirable, in the second example, to pass that information to anyone planning to spend time in the house that day, Zac's day care, etc., regardless again of the respective communications channels used to reach the intended recipients. In each of these examples, embodiments facilitate allowing the context of the desired communication, rather than the communications channels, to drive the communications mode.

In some embodiments, rather than treating the “extended circle” 720 as part of the “family” and participating in certain family conversations, other techniques are used to contact those parties. For example, as described more below, asynchronous group messaging may be used to contact all the affected parties as a group. Similarly, various types of communications may be used to contact parties considered to be part of the “outer circle” 740 or “others” 750. In certain embodiments, the “outer circle” 740 may include those parties that are in an address book associated with the user supersystem 100, otherwise approved via some technique by one or more members of the “inner circle” 710, etc. For example, in one embodiment, various types of communications modes may be allowed for “outer circle” 740 members (e.g., bi-directional, synchronous and asynchronous messaging), while communications with “others” 750 are restricted (e.g., only phone calls are allowed, communications may only be made to or received from “others” 750, etc.).

It will be appreciated that many other family designations are possible, and each may be associated with many different types of homes, family communications hierarchies, etc. As such, the family communications environment 700 of FIG. 7 is intended only to provide an illustrative context for the descriptions of embodiments herein. The concepts presented in FIG. 7 will also become more clear through descriptions of various embodiments in the remaining figures.

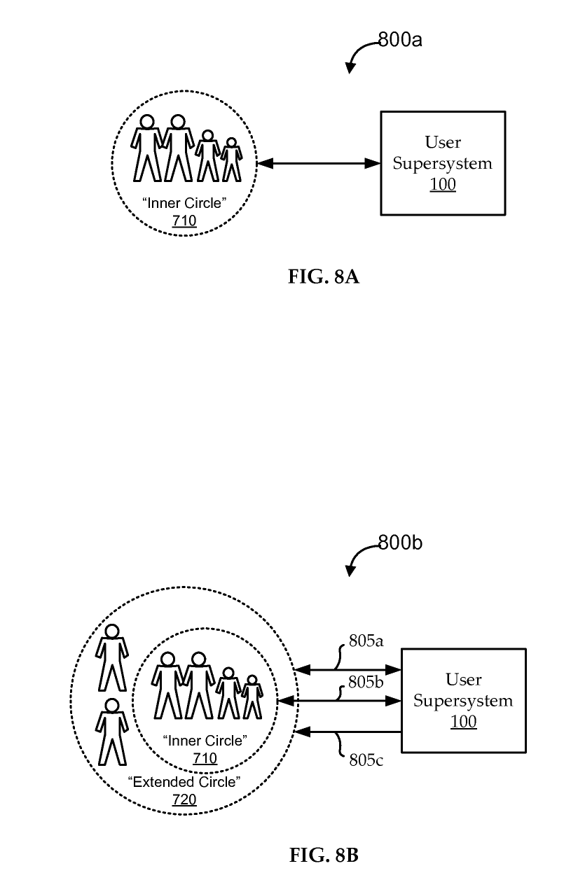

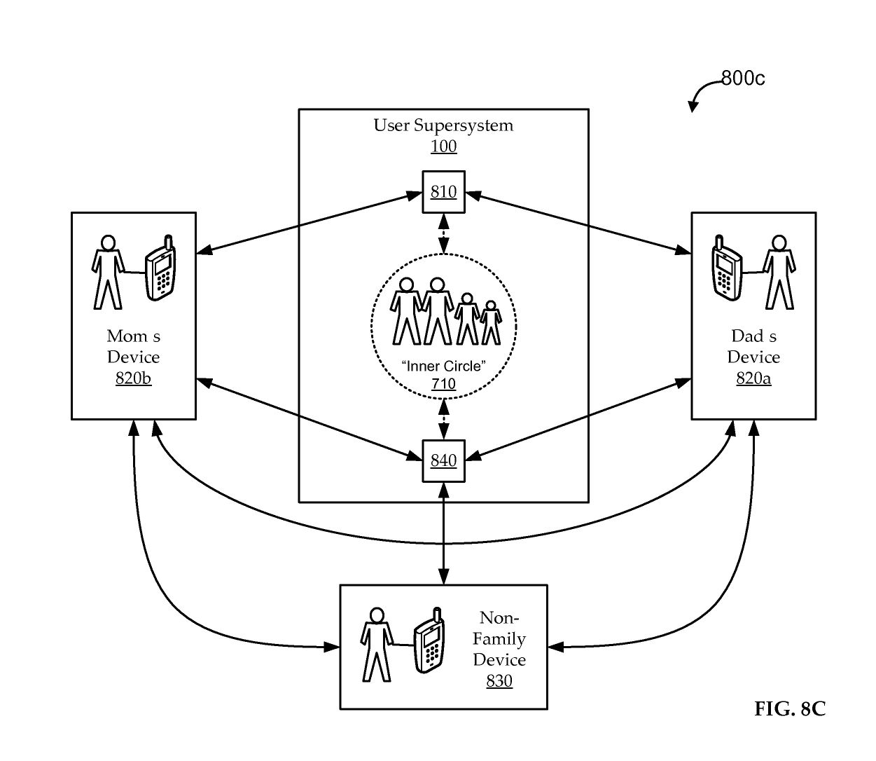

FIGS. 8A-8C show various types of context-driven communications that may be facilitated via the user supersystem 100, according to various embodiments. Turning first to FIG. 8A, a communications mode 800a is presented whereby family “inner circle” 710 members communicate with each other via the user supersystem 100. The “inner circle” 710 is shown simply as a dashed region to indicate the “inner circle” 710 members interfacing with the user supersystem 100 directly as part of the “inner circle” 710, and not using their individual devices.

In some embodiments, members of the “inner circle” 710 (e.g., and, in some cases, members of the “extended circle” 720 and/or others) conduct certain conversations simply as part of the household through the user supersystem 100. For example, as with a traditional home phone, the caller may not log in or otherwise identify himself prior to initiating a conversation; rather, conversations may be directed to or from the household. In one embodiment, this functionality may be facilitated at least partially by associating the user supersystem 100 with a single phone number (e.g., and/or IP address, email address, SMS address, etc.).

Various other communications modes 800b are shown in FIG. 8B. As illustrated, some or all of the “inner circle” 710 communications functionality may be extended in some embodiments to the “extended circle” 720. In one embodiment, all “inner circle” 710 conversations are shared with, and may include members of, the “extended circle” 720 (e.g., arrows 805a and 805b represent a single communications mode). In another embodiment, conversations with the “inner circle” 710 represent one communications mode (e.g., arrow 805b), while conversations with the “extended circle” 720 involve similar functionality but represent another communications mode (e.g., arrow 805a). In still another embodiment, conversations with the “inner circle” 710 represent one communications mode (e.g., arrow 805b), while conversations with the “extended circle” 720 involve limited functionality and represent another communications mode (e.g., arrow 805c, indicating only one-way messaging as an illustrative limitation on the functionality).

Some of the same and other communications modes 800c are illustrated in FIG. 8C. As illustrated, the user supersystem 100 may include a family messaging component 810 and an individual messaging component 840. Each component may be used in conjunction with one or more of the communications modes 800c. For the sake of illustration, two family member devices 820 and one non-family device 830 are shown. It is worth noting that “member device” is used generally herein to include any type of device outside the user supersystem 100 capable of accessing functionality of the user supersystem 100. For example, member devices 820 may include phones, computers, tablets, and/or any device capable of running a web interface, a dedicated application, etc.

In one embodiment, a family conversation is occurring, involving substantially synchronous communications shared by all the members of the family “inner circle” 710 (note that the family conversation could, similarly, involve members of the “extended circle” 720, as described above). Members of the “inner circle” 710 using the user supersystem 100 may be in substantially real-time conversation over one or more communications channels with Dad's device 820a and Mom's device 820b via the family messaging component 810 (e.g., as part of a “family chat,” as described below). Notably, in some embodiments, other family member devices 820 may be included in the conversation (e.g., receiving substantially real-time updates to the conversation), even when the associated family member is not participating in the conversation, using the user supersystem 100 to participate in the conversation, etc. For example, the family messaging component 810 may treat the conversation as an “all-to-all” conversation among the family members.

In another embodiment, individual synchronous or asynchronous (e.g., or substantially synchronous) communications are occurring, involving the user supersystem 100. For example, a family member may call Dad's device 820a, Mom's device 820b, a non-family device 830, etc. from the user supersystem 100, which may be facilitated via the individual messaging component 840. Conversely, Dad, Mom, a non-family member, etc. may call the family's home on the user supersystem 100, which may also be facilitated by the individual messaging component 840. Notably, some embodiments of the user supersystem 100 are configured to only facilitate communications of which the user supersystem 100 is a part. For example, a call from Dad's device 820a directly to Mom's device 820b would still be made as if the user supersystem 100 were not present (e.g., from Dad's cell to Mom's cell over their respective cell networks).

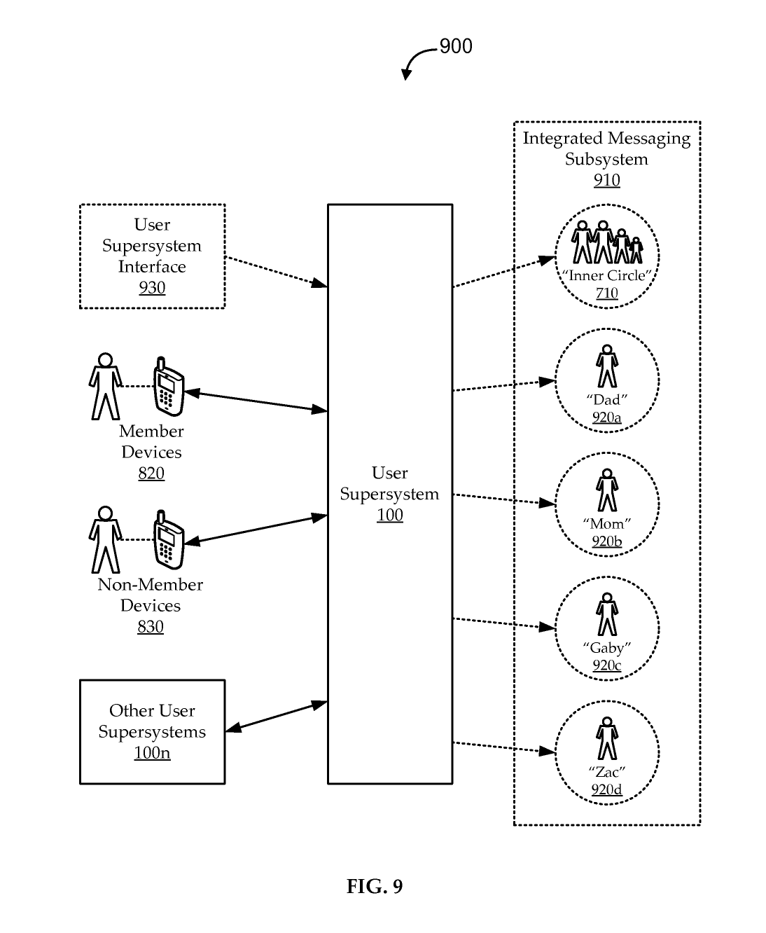

FIG. 9 shows a simplified communications system view 900 of some of the same and other communications modes illustrated by the embodiments and examples of FIGS. 8A-8C. Embodiments of the user supersystem 100 are in communication with various types of endpoints, including member devices 820, non-member devices 830, other user supersystems 100n (e.g., there may be “supersystem-to-supersystem” communications modes), etc. Each endpoint may be able to engage with the user supersystem 100 via one or more communications modes.

The user supersystem 100 may be configured to provide communications functionality via a supersystem interface 930. As will be appreciated from the descriptions above (e.g., with reference to FIGS. 1A, 1B, 1C, 5, and 6), the supersystem interface 930 may include various types of user interface components, such as a touchscreen, microphone, speaker, camera, hard and/or soft controls, etc. Embodiments of the user supersystem 100 may provide messaging functionality to family members as part of an integrated messaging subsystem 910. For example, family members may interface with the integrated messaging subsystem 910 via the supersystem interface 930 as individual members 920 or as a (e.g., unidentified) representative the family, for example, as the “inner circle” 710.

In one embodiment, Mom wants to call Dad from home. Mom may interact (e.g., as Mom 920b or as an unidentified member of the family “inner circle” 710) with the integrated messaging subsystem 910 via the supersystem interface 930. Through this interaction, Mom sends a message to Dad's member device 820 (e.g., a call or text to Dad's cell phone).

In another embodiment, Mom wants to ask if someone in the family can pick up dinner on their way home. If Mom is home, she may again interact (e.g., as Mom 920b or as an unidentified member of the family “inner circle” 710) with the integrated messaging subsystem 910 via the supersystem interface 930 to synchronously message the entire “inner circle” 710 (e.g., via all their member devices 820 and respective communications channels). If Mom is not home, she may interact with the integrated messaging subsystem 910 via her member device 820 to synchronously message the entire “inner circle” 710 (e.g., via all their member devices 820 and respective communications channels, including the user supersystem 100). In certain embodiments, members can participate in, but not initiate, family conversations through a member device 820 (e.g., the conversation must be initiated from the user supersystem 100).

In yet another embodiment, Mom wants to leave a message for the household, indicating that the upstairs toilet is not working and a plumber is supposed to arrive at around 3:00 pm. Mom may interact with the integrated messaging subsystem 910, either from home via the supersystem interface 930 of the user supersystem 100 or from her member device 820, to asynchronously message the entire family (e.g., “inner circle” 710 and/or “extended circle” 720). In various embodiments, the asynchronous message may be left in one or more formats (e.g., as a video message, an audio message, a “scribbled” note (drawn via the touchscreen interface), a text message, etc.). Further, the asynchronous message may be accessible only via the user supersystem 100 or sent to one or more of the member devices 820. For example, where the message is location sensitive (e.g., the arrival of the plumber may only affect those who will be in the house at that time), it may be preferable for the message to be displayed as a family activity or message on the tablet system 120 of the user supersystem 100.

In yet another embodiment, Mom wants to leave a message for Zac, asking him to clean his room when he gets home from school. As with the plumber example above, this message may be more location sensitive than time sensitive. For example, if Mom were to send the message to Zac's member device 820 while Zac was in school, it may be likely that Zac would have his phone off, not remember by the time he arrived at home, etc. As such, it may be desirable for the message to be left as a task for Zac on the user supersystem 100 at home, rather than on Zac's member device 820. Mom may interact with the integrated messaging subsystem 910, either from home via the supersystem interface 930 of the user supersystem 100 or from her member device 820, to asynchronously message Zac (e.g., to flag the message for Zac 920d). When Zac arrives at home, he may then retrieve the message through the supersystem interface 930. For example, an icon representing Zac (e.g., a thumbnail image) may be displayed on an always-on dashboard screen of the tablet system 120, with a flashing indicator in the corner of the icon indicating that Zac has a task waiting for him.

Embodiments are configured with an assumption that different functionality is desired for “in the house” users and “outside the house” users. For example, the supersystem interface 930 may be designed in a highly context-driven fashion, such that family interactions with the home-centric device are intuitive and supplement (rather than supplant) otherwise traditional family interactions. As discussed above, these family interactions are typically driven by the context of the interaction. For example, deciding whether to leave a note on the refrigerator or to pick up the phone may be driven by contextual factors, such as urgency of the message, desired synchronicity of the communication (e.g., whether immediate feedback is desired), location sensitivity, etc.

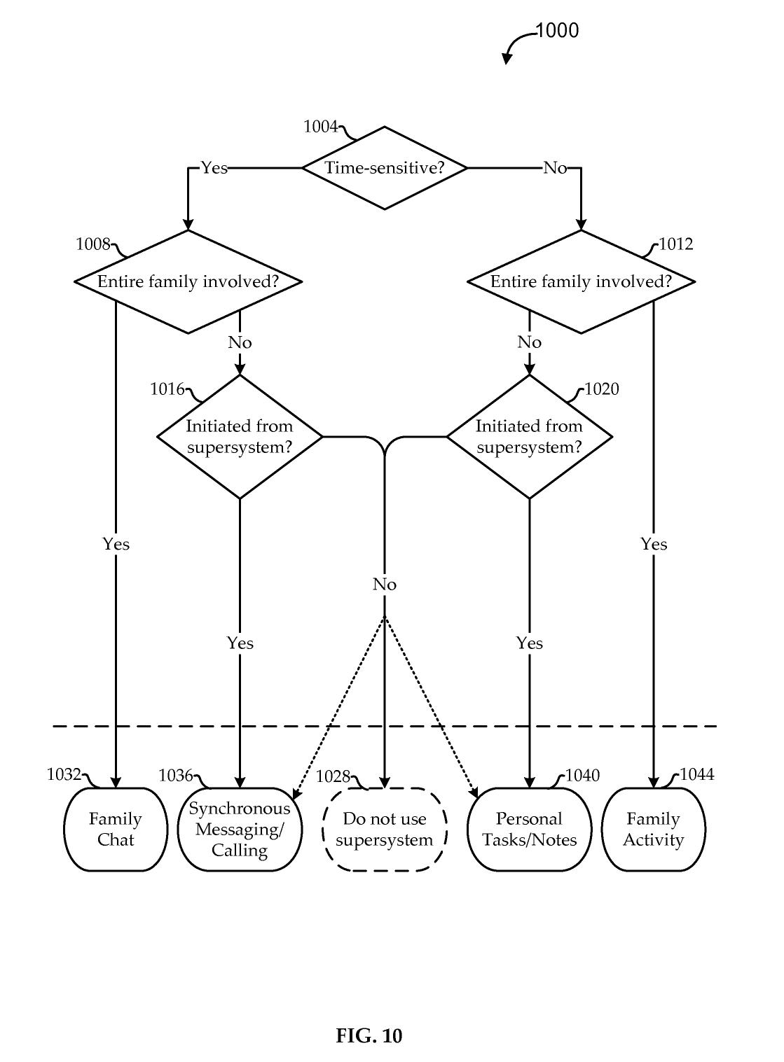

FIG. 10 shows a flow diagram of an illustrative method for using contextual factors to drive communications mode determinations, according to various embodiments. Embodiments of the method 1000 begin at block 1004 with a determination of whether the communication context is time-sensitive (e.g., urgent). As used in the context of the method 1000, the urgency of the communication may be relative and/or apparent. For example, non-urgent communications may include recurring events or tasks (e.g., take out the trash every Tuesday night, Mom's birthday on October 17, etc.), future events (e.g., Gaby's soccer game on Sunday). By contrast, urgent events may relate to relatively near-term and/or important events (e.g., tonight's dinner, a change in plans, etc.), communications for which an immediate or relatively near-term response is desired, etc.

If a determination is made that the communication context is time-sensitive, another determination may be made at block 1008 as to whether the entire family is involved (e.g., responses from some or all the members of the family are desired, all members of the family are potentially interested or affected, etc.). If a determination is made that the communication context is not time-sensitive, a similar or identical determination may be made at block 1012 as to whether the entire family is involved When the context of the communication is determined to be relatively time-sensitive and family-related, a family conversation (e.g., “family chat”) may be invoked at block 1032 as the appropriate communications mode. When the context of the communication is determined to be family-related, but not time-sensitive, a family activity may be invoked at block 1044 as the appropriate communications mode.

In one example, Gaby is the first family member to get home and wants to know what is for dinner. She intuitively pushes an image of the family on the home screen of the user supersystem 100, and a family chat begins, whereby a substantially real-time, synchronous conversation takes place among the family members (e.g., via their respective member devices 820) about dinner. By virtue of the context of the communication, Gaby is driven to an appropriate communications mode (e.g., the family chat mode 1032, in this example) of the integrated messaging subsystem 910 via the supersystem interface 930.

In another example, Gaby is the first family member to get home and wants to let everyone in the family know about her school play next Sunday. In some embodiments, she may again intuitively push the image of the family on the home screen of the user supersystem 100, and a family chat begins. She may then write a message about the school play, and associate it with a particular date and time. Instead of (e.g., or in addition to) initiating a conversation through family chat, the message may become a family activity and be added to a list of family activities, accordingly. Again, by virtue of the context of the communication, Gaby is driven to an appropriate communications mode (e.g., the family activity mode 1044, in this example) of the integrated messaging subsystem 910 via the supersystem interface 930.

If a determination is made, either at block 1008 or block 1012, that the entire family is involved in the communication, another determination may be made as to whether the communication was initiated from the user supersystem 100 at block 1016 or block 1020, respectively. At block 1016, a determination may be made that the communication is time-sensitive (e.g., from block 1004) and initiated from the user supersystem 100, but not involving the entire family (e.g., from block 1008). In that case, synchronous messaging may be selected at block 1036 as an appropriate communications mode. For example, suppose Dad is home (such that he initiates the conversation from the user supersystem 100) and wants to have a conversation (such that the communication is relatively time-sensitive) with a co-worker at the office (such that the entire family is not involved). Dad may use an address book feature of the user supersystem 100 to find the co-worker, and he may press a “call office” indicator by the address book contact to initiate a call to the co-worker. Notably, once again, by virtue of the context of the communication, Dad is driven to an appropriate communications mode (e.g., the synchronous messaging mode 1036) of the integrated messaging subsystem 910 via the supersystem interface 930.

According to corresponding block 1020, a determination may be made that the communication again initiated from the user supersystem 100 and does not involve the entire family (e.g., from block 1012), but, in this case, is not time-sensitive (e.g., from block 1004). Because the message is not time-sensitive, there may be no reasons to use synchronous messaging. Instead, asynchronous messaging, like a personal tasks and notes mode, may be selected at block 1040 as an appropriate communications mode. For example, suppose Dad is home (such that he initiates the conversation from the user supersystem 100) and wants to leave a note telling the kids that dinner is in the refrigerator (such that the communication is not time-sensitive and only involves part of the family). Dad may select an image of Gaby on the home screen (e.g., or a messaging screen) of the supersystem interface 930, and be brought to an interface through which he may leave Gaby the message about dinner. He may then tag the message for Zac, causing the message to appear as a “task,” “note,” or similar on the children's respective message pages. Yet again, by virtue of the context of the communication, Dad is driven to an appropriate communications mode (e.g., the asynchronous messaging mode 1040) of the integrated messaging subsystem 910 via the supersystem interface 930.

If a determination is made, either at block 1016 or block 1020, that the communication did not initiate from the user supersystem 100, the result may differ according to different embodiments. According to some embodiments, if the communication did not initiate from the user supersystem 100, no communications mode is invoked at block 1028; the user supersystem 100 is not involved in the communication. For example, as discussed above, some embodiments of the user supersystem 100 may facilitate only communications in which the user supersystem 100 participates.

According to other embodiments, if the communication did not initiate from the user supersystem 100, but the communication is relatively time-sensitive (e.g., according to block 1004), the user supersystem 100 may receive the communication synchronously. For example, if an outside caller calls a phone number associated with the user supersystem 100, embodiments of the user supersystem 100 may act as a home phone for receiving the call. As when the communication did initiate from the user supersystem 100 according to block 1016, the synchronous messaging communications mode 1036 may be selected. According to various embodiments, particular functionality of the synchronous messaging communications mode 1036 (e.g., back-end network functionality, look-and-feel, etc.) may differ according to whether the communication initiated from the user supersystem 100.

According to still other embodiments, if the communication did not initiate from the user supersystem 100 (e.g., according to block 1020) and is not time-sensitive (e.g., according to block 1004), the user supersystem 100 may allow access to personal or family messaging. For example, a further determination may be made as to whether the communication initiated from a member device 820. If the communication initiated from a member device 820, the member may be able to get access through that device to the family's individual, “inner circle” 710, etc. asynchronous messaging functionality (e.g., remotely via the integrated messaging subsystem 910). As when the communication did initiate from the user supersystem 100 according to block 1020, the asynchronous messaging communications mode 1040 may be selected. According to various embodiments, particular functionality of the asynchronous messaging communications mode 1040 (e.g., back-end network functionality, look-and-feel, etc.) may differ according to whether the communication initiated from the user supersystem 100.

It will be appreciated from the above description that various contextual factors may drive a determination of which communications mode to use. While the method 1000 specifically indicates time-sensitivity, audience, and initiating device/system as contextual factors, other embodiments may use additional and/or alternate factors. For the sake of illustration, some other embodiments consider location-sensitivity of the communication.

For example, suppose Dad is at home and wishes to leave Zac a note to clean his room when he gets home and a note that he will be ten minutes late picking him up from school. For both notes, a determination is made that the communications do not involve the entire family (e.g., from block 1012), but do initiate from the user supersystem 100 (e.g., from block 1020). In this case, an important contextual consideration may be where to leave Zac each message, rather than whether the messages are time-sensitive (e.g., from block 1004). Alternatively, the messages may be considered not time-critical (e.g., they both happen later in the day and do not necessitate a reply), but carrying different location sensitivities as an additional context factor. The asynchronous messaging mode 1040 may include sub-modes whereby the messages may be tagged as either “post to home” (e.g., display in Zac's messaging area of the tablet system 120) or as “send to Zac” (e.g., communicate as a text message to Zac's cell phone).

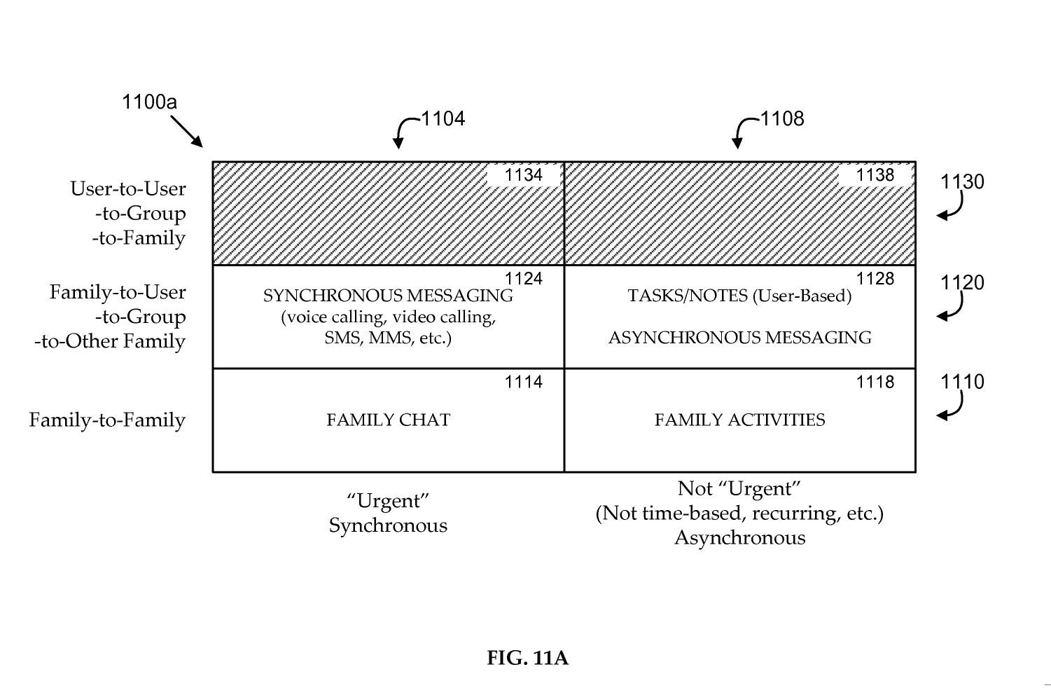

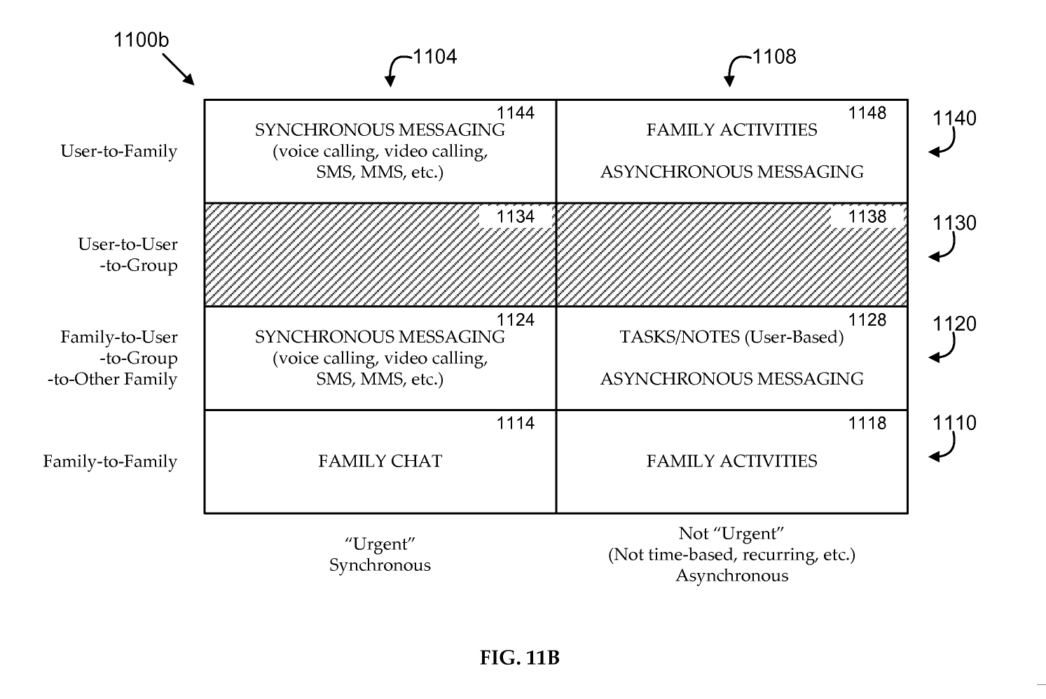

FIGS. 11A and 11B show additional approaches to context-driven communications mode determinations, according to various embodiments. For the sake of added clarity, the contextual factors and communications modes shown in FIGS. 11A and 11B are substantially similar to those described with reference to the method 1000 of FIG. 10. Each of FIGS. 11A and 11B shows a matrix having various contextual factors on the axes and various communications modes in the cells.

Turning first to FIG. 11A, a matrix 1100a is shown having two columns and three rows. The first column 1104 indicates time-sensitive communications modes (e.g., including synchronous types of communications). The second column 1108 indicates non-time-sensitive communications modes (e.g., including asynchronous types of communications, recurring tasks, etc.). The first row 1110 indicates family-to-family (i.e., communications within the family group between family members) communications, the second row 1120 indicates family-to-other communications (e.g., including family-to-device, family-to-group, family-to-other family, etc.), and the third row 1130 indicates user-to-any communications (e.g., including communications initiating from external devices).

According to cell 1114, time-sensitive, family-to-family communications may invoke the family chat communications mode. According to cell 1118, non-time-sensitive, family-to-family communications may invoke the family activities communications mode (e.g., asynchronous messaging for the entire family). According to cell 1124, time-sensitive, family-to-other communications may invoke one or more synchronous messaging communications modes (e.g., voice or video calling or chatting, SMS, MMS, etc.). According to cell 1128, non-time-sensitive, family-to-other communications may invoke the one or more asynchronous messaging communications modes (e.g., including user-based tasks or notes).

Notably, cells 1134 and 1138 indicate that user-to-any communications may not be handled by the user supersystem 100, regardless of time sensitivity. For example, as discussed above, some embodiments of the user supersystem 100 may facilitate only communications in which the user supersystem 100 participates. Other embodiments, however, may deal with external user communications differently.

For example, FIG. 11B shows another matrix 1100b having two columns and four rows. The first three rows from the bottom (i.e., rows 1110, 1120, and 1130) are substantially identical to the corresponding rows of FIG. 11A. However, the user-to-any communications, shown as row 1130 of FIG. 11A, have been split into two categories, shown as rows 1130 and 1140 of FIG. 11B. In the embodiment of FIG. 11B, row 1130 indicates that any communications between an external device and one or more other external devices is not handled by the user supersystem 100 (e.g., the user supersystem 100 is not involved).

However, according to row 1140, external devices may be able to interact with the family via the user supersystem 100. For example, according to cell 1144, time-sensitive, user-to-family communications may invoke some or all of the synchronous messaging communications mode features. According to cell 1148, non-time-sensitive, user-to-family communications may invoke some or all of the asynchronous messaging communications mode features.

### Family Chat Embodiments

Various embodiments and examples described above with reference to FIGS. 7-11 relate to a so-called “Family Chat” communications mode (e.g., communications mode 1032 of FIG. 10, cell 1114 of FIGS. 11A and 11B, etc.). Embodiments of the family chat mode facilitate a synchronous conversation among all the members of the designated family group (e.g., the “inner circle” 710 and/or the “extended circle” 720). Typically, the conversation involves the user supersystem 100 (e.g., as a communications hub for the conversation) and member devices 820 designated to be associated with each of the family members.

For example, as discussed above with reference to FIG. 8C, a family chat embodiment may involve substantially synchronous communications shared by all the members of the family “inner circle” 710 (note that the family chat could, similarly, involve members of the “extended circle” 720, as described above). Members of the “inner circle” 710 using the user supersystem 100 may be in substantially real-time conversation over one or more communications channels with Dad's device 820a and Mom's device 820b via the family messaging component 810. Other family member devices 820 may be included in the conversation (e.g., receiving substantially real-time updates to the conversation), even when the associated family member is not participating in the conversation, using the user supersystem 100 to participate in the conversation, etc. For example, the family messaging component 810 may treat the conversation as an “all-to-all” conversation among the family members.

The family chat communications mode may be initiated in a number of ways, for example, via the supersystem interface 930 of the user supersystem 910, via a typical chat function of a member device 820, via a specialized application (e.g., an “app”) for a member device 820, etc. In one embodiment, as described above, a user of the user supersystem 100 (e.g., a family member) may enter a messaging screen, select a family icon, etc. to enter the family chat communications mode using the user supersystem 100. In another embodiment, a member can message the user supersystem 100 from a member device 820 using an address (e.g., a phone number, or other type of message addressing scheme).

It will be appreciated that certain security features may be included in certain embodiments. In one embodiment, the family members have a special address for the user supersystem 100 by which they can participate (e.g., add to) the family chat feed. For example, it may be the responsibility of the family members to protect the address so as to limit the devices permitted to participate in the family chat. In another embodiment, member devices 820 must send authentication credentials to participate in the family chat (e.g., devices must register, users must log in, etc.). In still another embodiment, a certain authorized application must be installed on the device to allow participation in the family chat. The authorized application may, for example, use secure protocols and/or other authentication techniques.

It is worth noting that embodiments of the family chat communications mode operate as a continuous feed. For example, the family chat is always “on,” such that any member of the family can add to the chat feed at any time from the user system 100 and/or from any member device 820. As such, terms like “initiate” in the context of a family chat may generally refer to any type of engagement in the family chat feed. For example, even where a family chat only begins once and lasts for an effectively endless duration, each participant may be considered to initiate the family chat communications mode by actively participating in or tracking progress of a conversation over the feed.

In some embodiments, a family member (e.g., a member of the “inner circle” 710 and/or the “extended circle” 720) engages with the family chat mode of the user supersystem 100 through the tablet system 120. For example, as described above, a context driven determination of the communications mode may have occurred, either by the interaction design of the supersystem interface 930, or by conscious action by the family member. Upon entering the family chat mode, the display may be configured for that mode, for example, to optimize the family member's experience.

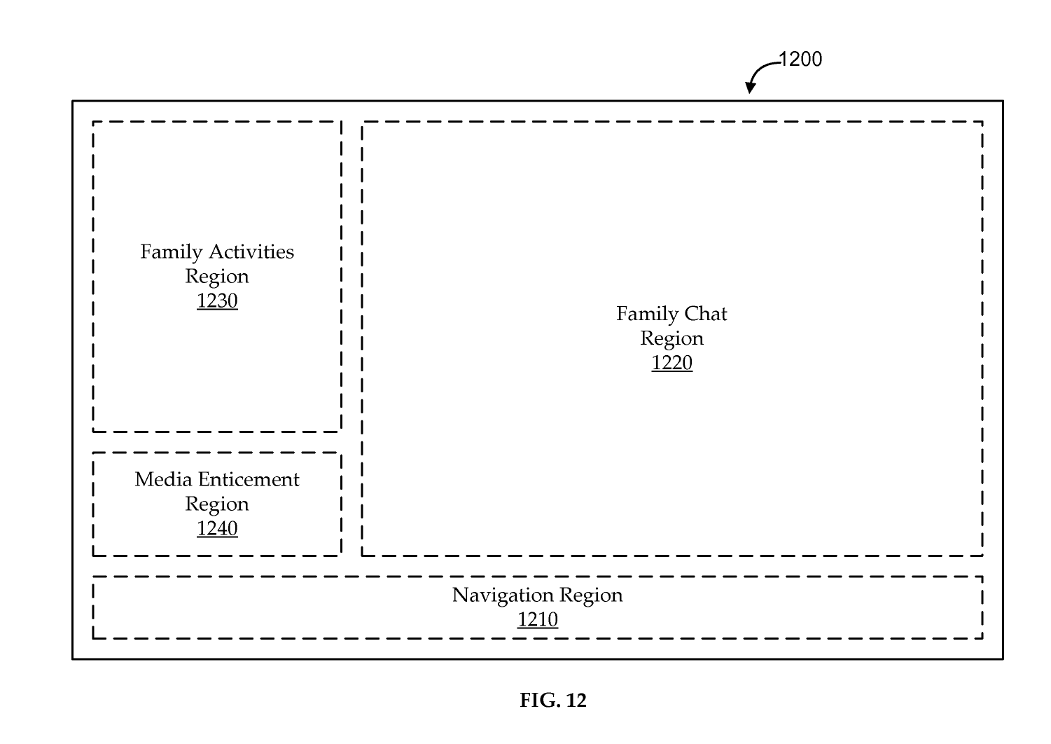

FIG. 12 shows an illustrative display configuration 1200 for a family chat mode, according to various embodiments. In some embodiments, the display configuration 1200 is provided via a display of the tablet system 120 upon entry into the family chat mode. The display configuration 1200 includes a navigation region 1210, a family chat region 1220, a family activities region 1230, and a media enticement region 1240. These regions are intended to be illustrative only, and should not be construed as limiting the scope of the invention.

In some embodiments, the navigation region 1210 includes one or more icons configured to guide the user to major categories of functionality. For example, the navigation region 1210 may include “Home,” “Phone,” “Messaging,” and “Info” icons. The “Home” icon may provide the user with a home dashboard screen from which frequently accessed functionality may be available, the “Phone” icon may provide the user with access to calling features (e.g., voice and/or video calls, address books, etc.), the “Messaging” icon may provide the user with access to messaging features (e.g., integrated family- and/or user-specific messaging lists, chat functions, etc.), and the “Info” icon may provide the user with access to other informational types of functionality (e.g., access to the Internet, search functions, drawing applications, etc.).

Embodiments of the family activities region 1230 display family activity-related information. For example, as described above, certain communications contexts may drive use of family activities, which may include family messages that are associated with a particular date (e.g., or a recurring date), urgency, expiration, etc. In some embodiments, the family activities region 1230 also includes user-based activities (e.g., tasks, notes, and/or activities associated with a particular family member). For example, the family activities region 1230 may include a list of all activities for all family members due that day. In certain embodiments, the family activities region 1230 further includes related information, such as a calendar, date and time, current weather, etc.

Embodiments of the media enticement region 1240 may include one or more features to encourage users to interact with content functionality of the user supersystem 100. For example, in one embodiment, a dynamic icon is shown to look like a stack of photos, with the most recent family photo (e.g., uploaded to the user supersystem 100, taken by the tablet system 120 camera, taken by the handset system 130 camera, etc.) on top of the virtual stack. Clicking on the “photo stack” icon may navigate the user to a photo booth as a portal to various types of media capture and/or editing functionality.

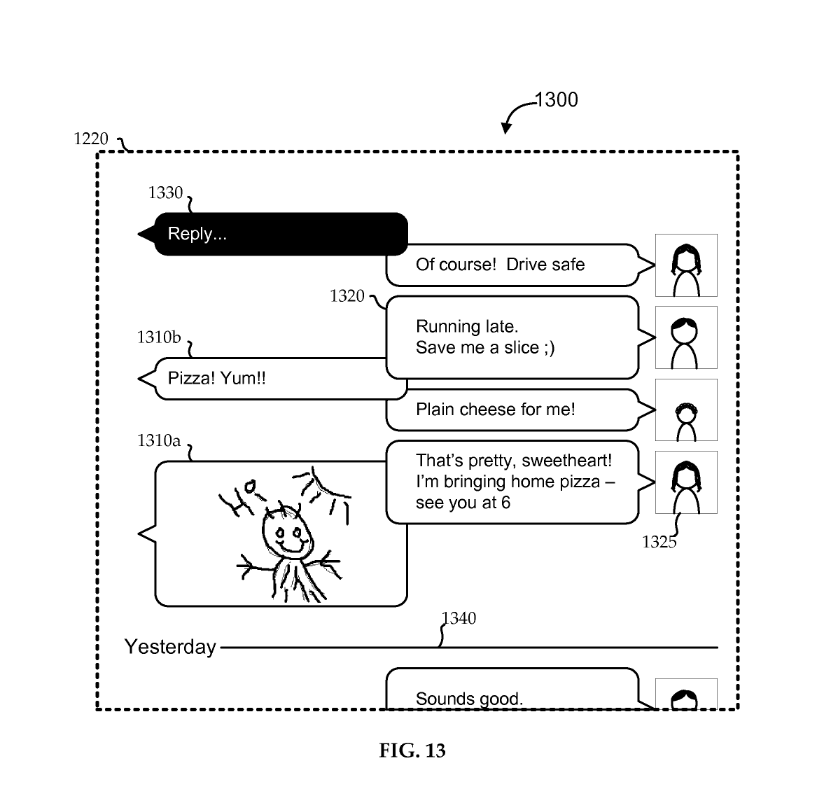

Embodiments of the family chat region 1220 display various family chat features, including a rendering of the family chat feed. Various examples of displays within the family chat region are shown in FIGS. 13-16. It will be appreciated that many types of display are possible, and the display may change, depending on the device or system being used, the perspective from which the conversation is transpiring, the content of the conversation, etc. As such, the illustrative embodiments shown in FIGS. 13-16 are intended only as examples to illustrate certain functionality, and should not be construed as limiting the scope of the invention.

FIG. 13 shows an illustrative screenshot 1300 of a portion of a family chat conversation rendered within a family chat region 1220 of a user supersystem 100 display, according to various embodiments. It is assumed in the context of FIG. 13 that the family chat conversation is being rendered to a family chat region 1220 of the tablet system 120 display. The family chat region 1220 display includes internal bubbles 1310, external bubbles 1320, external bubble identifiers 1325, a prompt bubble 1330, and a time indicator 1340.

As illustrated, all communications originating from the user supersystem 100 (e.g., specifically from the tablet system 120 or from any component of the user supersystem 100) are rendered as the internal bubbles 1310. Conversely, all communications originating from other devices or systems are rendered as the external bubbles 1320. It may be assumed that whomever is using the tablet system 120 is aware of their own contributions to the family chat conversation. As such, there may be no need to identify the tablet system 120 user in the family chat region 1220 rendering of the family chat conversation.

In many typical chat systems, each party is pre-identified to the other party (e.g., the parties are specifically messaging each other, have logged in to a messaging application, etc.) Because the family chat conversation is an “all-to-all” conversation thread, however, there may be no way to know (e.g., other than using contextual cues, such as nicknames, writing style, writing content, etc.) who is contributing each of the portions of the conversation rendered in the external bubbles 1320. As such, embodiments include external bubble identifiers 1325 to identify the party contributing from an external device or system. The external bubble identifiers 1325 may be implemented in a number of different ways. In some embodiments, a thumbnail image is associated with each member device 820. In other embodiments, a name, character string, drawing, sound, and/or other identifier is used.

In typical embodiments, parties to the conversation do not identify themselves. This may be preferable, considering that embodiments of the family chat are implemented as a continuous feed with the participation of all members of the predefined family group. Thus, the external bubble identifiers 1325 may identify the contributors in other ways, such as by identifying the member device 820 contributing to the conversation. Of course, other techniques for identifying the contributor of a communication are possible according to other embodiments.

Further, because the family chat conversation may be a continuous thread (e.g., stream, feed, etc.), embodiments include one or more time indicators 1340 to help provide a temporal context other than the order of the contributions (e.g., rendered by the order of the bubbles). As illustrated, one time indicator 1340 may be a divider between each day's portion of the conversation. Other time indicators 1340 may include time indications on the bubbles (e.g., a timestamp displayed on each bubble, a timestamp accessible by interacting with a bubble, etc.). In certain embodiments, no time indicators 1340 are provided, and the conversation is viewed as a single, continuous feed.

The family chat conversation may be rendered to the family chat region 1220 in a number of different ways, depending, for example, on the communication channels and parameters used to generate the conversation thread. For example, embodiments of the user supersystem 100 are configured to automatically render SMS and MMS messages into a graphical format, like the one illustrated in the screenshot 1300. The conversation illustrated in FIG. 13 may be an MMS feed, as at least one image is part of the conversation.

It is worth noting that the family chat conversation may include a number of features. One feature is that the internal bubbles 1310 are always rendered to one side of the family chat region 1220 and are unidentified, while the external bubbles 1320 are always rendered to another side of the family chat region 1220 and are identified (e.g., using external bubble identifiers 1325). Another feature is that the rendering is contextual, according to the perspective of the device on which the conversation is being rendered. For example, even though all family members may be participating in the conversation (e.g., actively or passively) at all times, the rendering of the conversation shows the perspective of the device being used by the member, rather than that of the member him or herself.

For the sake of illustration, it may be helpful to step through the conversation, beginning with the first bubble of the current day's portion of the conversation. Beginning at internal bubble 1310a, a family member added a drawing to the family chat. In the illustrative case, the drawing was created by Gaby (the family's daughter), using drawing-in-chat-context functionality of the tablet system 120 via its touchscreen display. Notably, the bubble is not identified, as it originated from the system (the tablet system 120) to which the conversation is being rendered. Also notably, in some embodiments, the conversation updates are substantially simultaneously getting communicated to Gaby's member device 820 (e.g., assuming she has one), even though she is contributing to the conversation via the tablet system 120.

Sometime after Gaby shares her picture, Mom responds, stating: “That's pretty, sweetheart! I′m bringing home pizza—see you at 6.” Because Mom is using her member device 820 (e.g., her cell phone), she is external to the tablet system 120 (e.g., and/or to the user supersystem 100), and her contribution is rendered as an external bubble 1320 with her respective external bubble identifier 1325. Zac (the family's son) then adds, “Plain cheese for me!” from his member device 820; and Gaby follows with “Pizza! Yum! !” from the tablet system 120. Again, Zac's contribution is rendered in an external bubble 1320 with his respective external bubble identifier 1325, while Gaby's contribution is rendered as an unidentified internal bubble 1310.

Next, Dad says, “Running late. Save a slice for me ;)” from his member device 820. Mom responds to Dad, “Of course! Drive safe” from her member device 820. Both Dad's and Mom's contributions are rendered as external bubbles 1320 with their respective external bubble identifiers 1325. Notably, it can be inferred from contextual clues that Mom's response is directed to Dad, even though there is no explicit identification to that effect and everyone is participating in the conversation. Embodiments facilitate efficient conversations by exploiting various types of inherent family dynamics, such as nicknames, speech patterns, family etiquette, and context.

Mom's reply to Dad is the most recent contribution to the conversation. As such, the next bubble may be rendered as a prompt bubble 1330, configured to receive a next contribution. Of course, as other contributions arrive from external devices, those contributions may be rendered to the family chat region 1220 (e.g., inserted under the prompt bubble 1330).

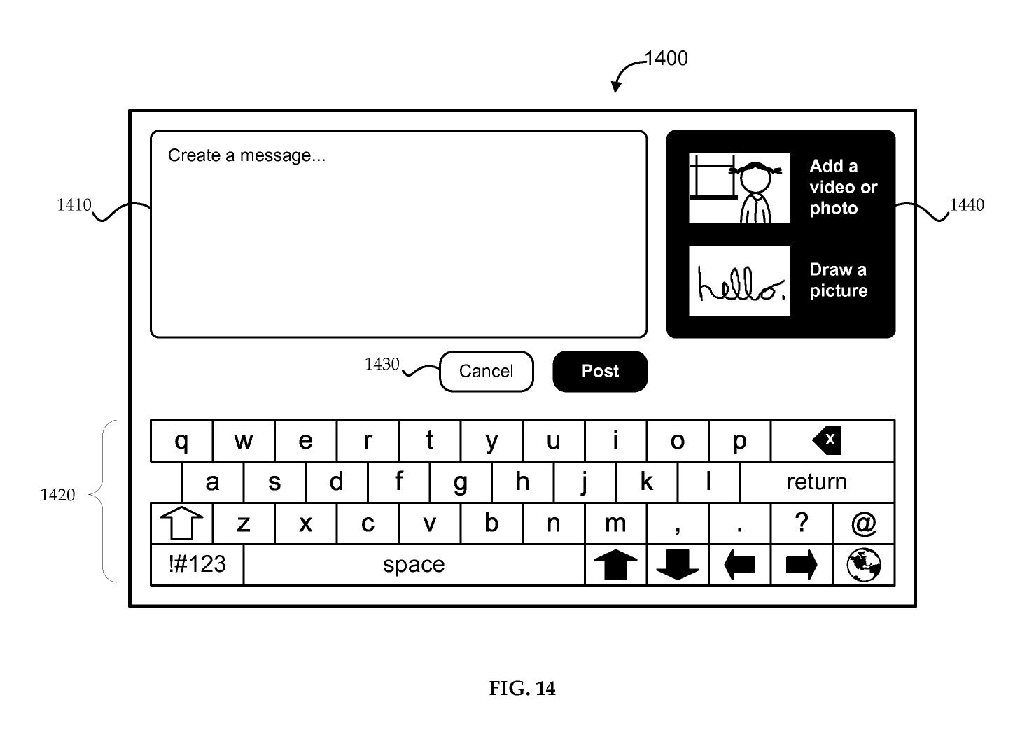

Adding a contribution to the conversation may be facilitated in a number of different ways, according to various embodiments. FIG. 14 shows a screenshot 1400 of an illustrative chat contribution interface. The chat contribution interface may include a text entry region 1410, a keypad region 1420, one or more soft controls 1430 (e.g., virtual buttons), and a media-in-context region 1440. It will be appreciated that the illustrated chat contribution interface may be modified in many ways without departing from the scope of the invention. As such, the particular chat contribution interface is intended only to illustrate certain types of functionality offered by some embodiments.

Embodiments of the text entry region 1410 are implemented substantially as a standard text entry field. Some embodiments include basic text entry functionality. Other embodiments include more advanced functionality, such as fonts, styles, text animations, graphics, emoticons, colors, etc. Entry into the text entry region 1410 may be effectuated using the touchscreen (e.g., by recognition of text written to the display using a finger or stylus, by recognition of gestures, etc.), using the microphone (e.g., by speech-to-text conversion), using the camera (e.g., by optical character recognition or scanning, by lip reading, etc.), using a peripheral input device (e.g., a peripheral keyboard), by using the keypad region 1420, etc.

Embodiments of the keypad region 1420 are configured to provide an intuitive text entry interface. In some embodiments the keyboard is configured as a “QWERTY” layout, while, in other embodiments, other layouts are used. Because the keypad region 1420 is a virtual keypad, the keyboard configuration may be easily (e.g., dynamically) changed for various reasons. For example, the keypad may change to accommodate touchscreen use (e.g., the letters in a region may enlarge as a finger approaches to mitigate mistyping), to accommodate different languages, different character sets, different types of navigation, etc. Certain special keys may also be included. For example, as illustrated, selecting a “!#123” key may change the keypad to allow for numeric and symbol entry; selecting various arrow keys may facilitate navigation through the text entry region 1410; selecting a key with a globe image may open a web browser; etc.

In some embodiments, it is desirable to supplement a conversation using media. Embodiments of the media-in-context region 1440 facilitate adding of media to the context of the family chat. As illustrated, an intuitive interface is provided for adding a video, photo, or drawing. For example, the drawing added to the conversation by Gaby in the example of FIG. 13 may have been added via the media-in-context region 1440.

In certain embodiments, selecting the media-in-context region 1440 opens a media interface, for example, according to the type of media being added. In one embodiment, selecting the “Add a video or photo” icon opens a photo booth interface that allows the user to select photos or videos, edit photos or videos, capture new photos or videos (e.g., through the camera of the tablet system 120 and/or the handset system 130), etc. In another embodiment, selecting the “Draw a picture” icon opens a drawing interface, through which users may draw a picture (e.g., via the touchscreen interface of the tablet system 120, etc.). In other embodiments, other media are accessible through other interfaces. For example, a piano keyboard interface may allow musical input, a sound recording and editing interface may allow for voice messages, etc.

Other interfaces and functionality may also be included. For example, embodiments of the soft controls 1430 may include any useful type of control functionality. In some embodiments, the soft controls 1430 include a “Post” and a “Cancel” soft button. Selecting the “Cancel” button may allow a user to cancel the current contribution to the family chat, so that the contribution is not included in the feed. Selecting the “Post” button may post the completed contribution to the family chat feed. For example, as described with reference to FIG. 13, rendering of each internal bubble 1310 and external bubble 1320 may occur after (e.g., or during, according to some embodiments) posting of the contribution.

As described above, rendering of the contribution may be context dependent, for example, according to the perspective of the device on which the contribution is being rendered. For example, FIG. 13 showed an illustrative rendering of a family chat conversation on a family chat region 1220 of a tablet system 120 display. The same conversation, however, may be rendered differently on different member devices 820 participating in the conversation.

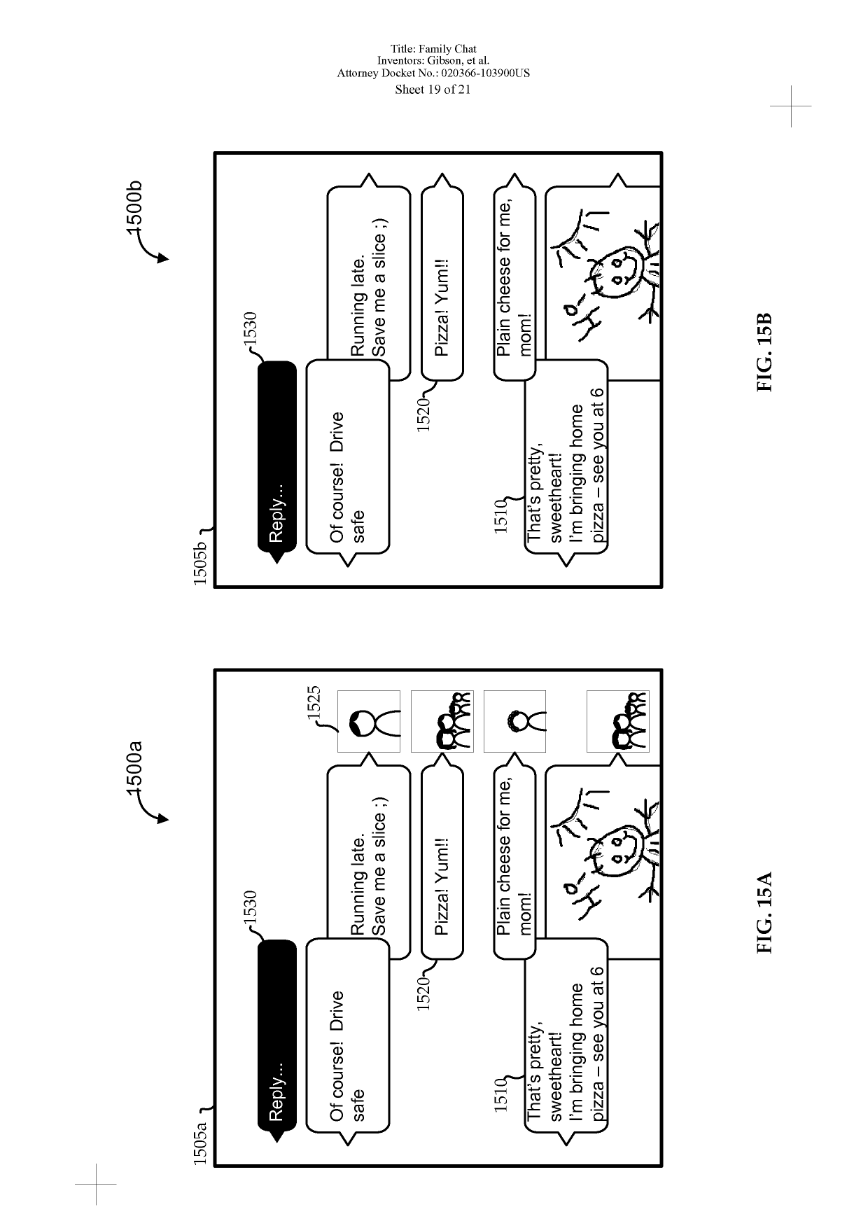

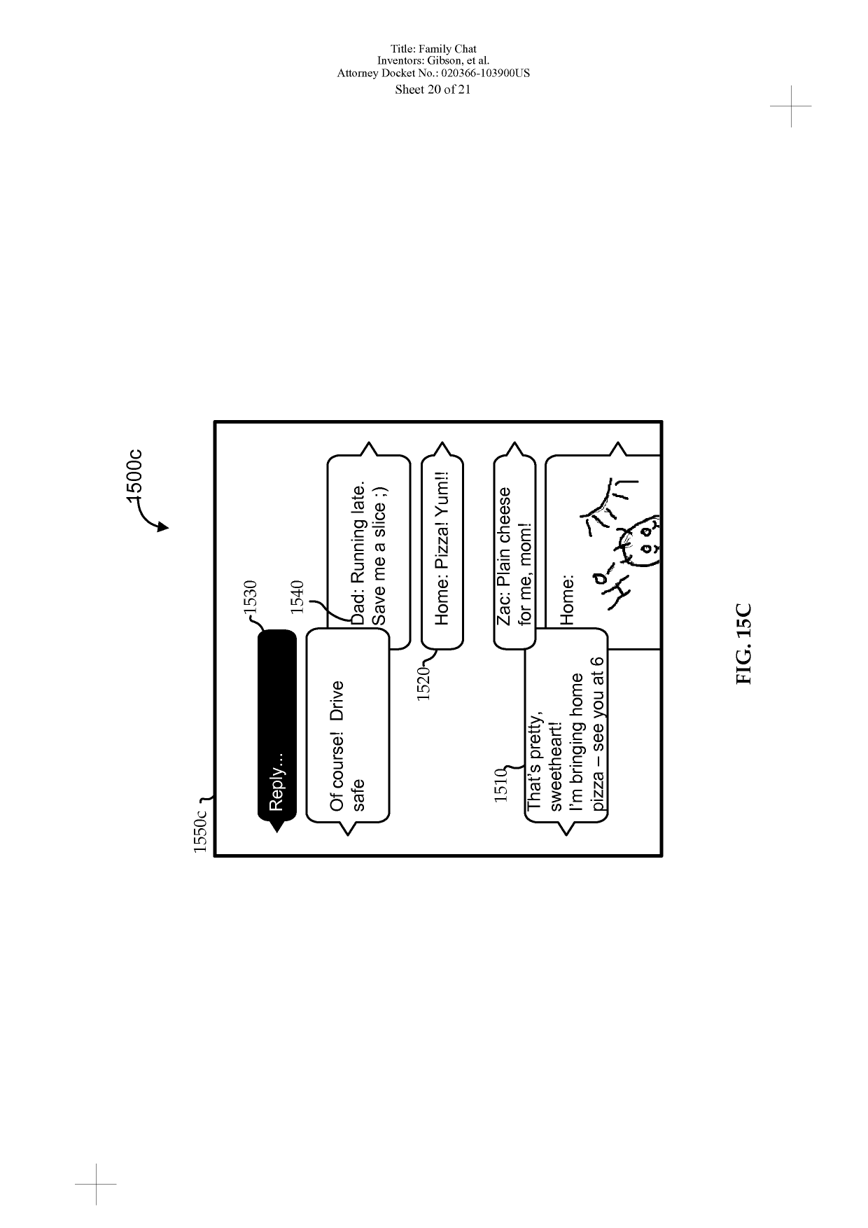

FIGS. 15A-15C show illustrative screenshots 1500 of a portion of a family chat conversation rendered within a family chat region 1505 of a member device 820 display, according to various embodiments. It is assumed in the context of the screenshots 1500 that the family chat conversation is being rendered to a family chat region 1505 of Mom's member device 820 display. As in the family chat region 1220 of the tablet system 120 display of FIG. 13, the family chat region 1505 of the member device 820 display includes internal bubbles 1510, external bubbles 1520, external bubble identifiers 1525, and a prompt bubble 1530.

As illustrated, all communications originating from Mom's member device 820 are rendered as the internal bubbles 1510. Conversely, all communications originating from other devices or systems are rendered as the external bubbles 1520. It may be assumed that Mom (e.g., or whomever is using Mom's member device 820) is aware of her own contributions to the family chat conversation. As such, there may be no need to identify her contributions to herself via the family chat region 1505 of her member device 820.

Conversely, all contributions to the family chat coming from external devices are rendered as external bubbles 1520. In some embodiments, the contributors of content in the external bubbles 1520 are identified by external bubble identifiers 1525. In one embodiment, as illustrated in FIG. 15A, the external bubble identifiers 1525 are implemented as picture icons, selected to represent the contributor. In another embodiment, as illustrated in FIG. 15B, no external bubble identifiers 1525 are used, and context alone is used to identify the contributors. In still another embodiment, as illustrated in FIG. 15C, the external bubble identifiers 1525 are implemented as text strings 1540 added to the external bubble 1520 content (e.g., “Dad:”).

As discussed above, embodiments of the user supersystem 100 are configured to allow interaction without user self-identification. As such, according to some embodiments, the contributions by Gaby originating from the user supersystem 100 are considered as from the family home, not from Gaby. For example, as illustrated in FIG. 15A, the external bubble identifier 1525 for Gaby's contribution shows an image icon representing the family, and not Gaby herself. Similarly, as illustrated in FIG. 15C, the external bubble identifier 1525 for Gaby's contribution shows a text string 1540 indicating “Home,” rather than Gaby.

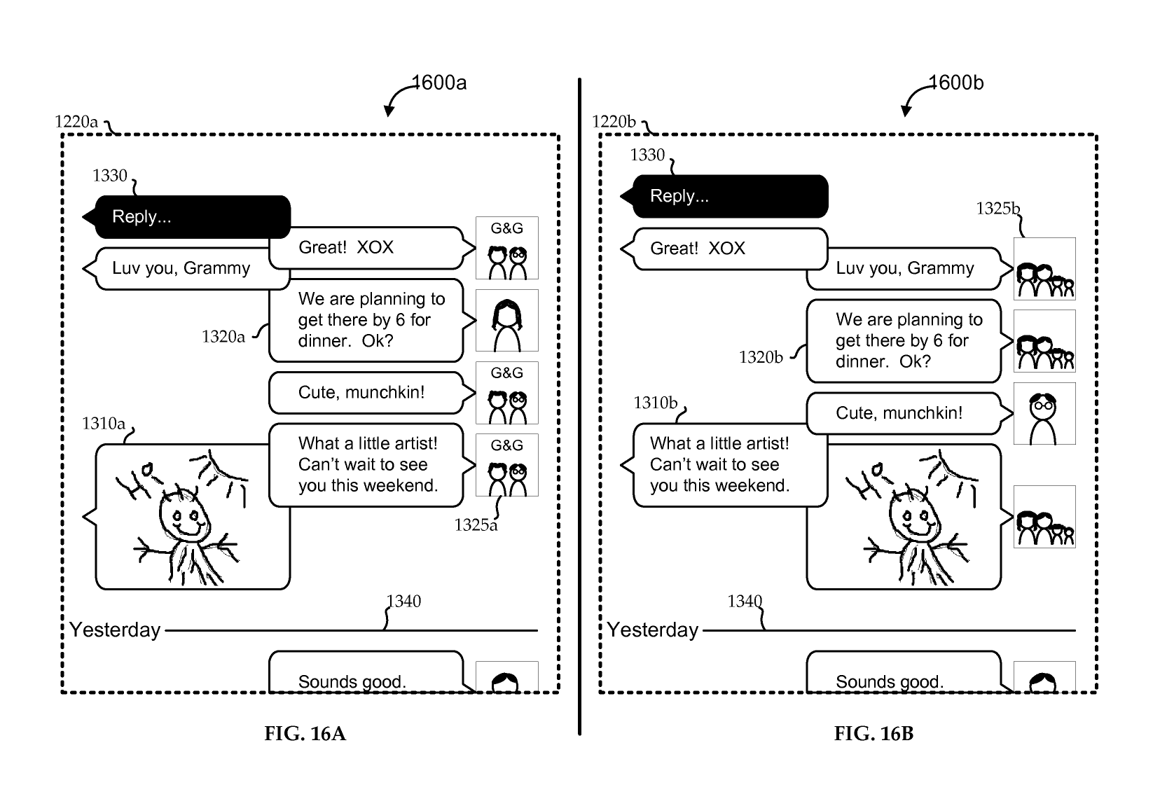

While FIGS. 13 and 15A-15C illustrate various types of family chat functionality, many other types of functionality are possible in many other contexts according to other embodiments. For example, FIGS. 16A and 16B show screenshots 1600 of an illustrative family chat conversation involving a family group that includes another family group. In particular, the screenshots 1600 illustrate a conversation between the same first family described above (the “Smiths”) and one set of Zac and Gaby's grandparents. Thus, the family chat conversation involves the Smiths' user supersystem 100, the Smiths' member devices 820, the grandparent's user supersystem 100 and the grandparent's member devices 820.

For the sake of illustration, suppose Gaby is using the Smiths' user supersystem 100, Grandma is using the grandparent's user supersystem 100, and everyone else is using their respective member devices 820. Many of the features shown in the screenshots 1600 are similar to those described above with reference to FIGS. 13 and 15A-15C. For example, the screenshot 1600a of FIG. 16A shows a family chat region 1220a of the Smiths' tablet system 120 display. The screenshot 1600b of FIG. 16B shows a family chat region 1220b of the grandparent's tablet system 120 display. Each respective family chat region 1220 display includes internal bubbles 1310, external bubbles 1320, external bubble identifiers 1325, a prompt bubble 1330, and a time indicator 1340.

Turning first to FIG. 16A, the screenshot 1600a illustrates the conversation from the perspective of the Smiths' user supersystem 100 (e.g., as seen by Gaby). All communications originating from the Smiths' user supersystem 100 (e.g., specifically from the tablet system 120 or from any component of the user supersystem 100) are rendered as the internal bubbles 1310a. Conversely, all communications originating from other devices or systems are rendered as the external bubbles 1320a and are identified by appropriate external bubble identifiers 1325a.

The portion of the conversation begins with Gaby contributing her drawing. Grandma responds by stating: “What a little artist! Can't wait to see you this weekend.” Grandpa then adds: “Cute, munchkin” Notably, while it would be possible to include Grandma and Grandpa individually as members of the Smiths' family group, it is assumed in this example that their “home” user supersystem 100 has been added instead. As such, according to some embodiments, all conversations from the grandparent's family group are seen as originating from the same endpoint from the perspective of the Smiths and their family chat.

Accordingly, Grandma is responding from the grandparents' user supersystem 100 and Grandpa is responding from his member device 820, but both external bubbles 1320a corresponding to their respective contributions are identified with the same external bubble identifier 1325a indicating the message as coming from the grandparent's home. The conversation then continues with a contribution from Mom via her member device 820, indicated as an external bubble 1320a with Mom's external bubble identifier 1325a. Gaby again replies, and her reply is rendered as an unidentified internal bubble 1310a. Finally, Grandma replies to both Gaby and Mom, but her contribution is again rendered as an external bubble 1320a identified as coming from the grandparents generally, rather than specifically from Grandma.

Turning now to FIG. 16B, the screenshot 1600b illustrates the same conversation, but from the perspective of the grandparents' user supersystem 100 (e.g., as seen by Grandma). All communications originating from the grandparents' user supersystem 100 are rendered as the internal bubbles 1310b. Conversely, all communications originating from other devices or systems are rendered as the external bubbles 1320b and are identified by appropriate external bubble identifiers 1325b.

The portion of the conversation again begins with Gaby contributing her drawing. This time, however, Gaby's contribution is rendered as an external bubble 1320b identified with an external bubble identifiers 1325 showing the Smith family, generally. Grandma's response is rendered as an unidentified internal bubble 1310, as it originated from her local user supersystem 100.

Recall that, in FIG. 16A, from Gaby's perspective, Grandpa's reply (“Cute, munchkin”) was rendered as an external bubble 1320 with an external bubble identifier 1325 indicating the grandparent's home, generically, even though it was sent from Grandpa's member device 820. In some embodiments, as illustrated in FIG. 16B, Grandpa's member device 820 is identifiable to the grandparents' user supersystem 100. As such, from Grandma's perspective, Grandpa's contribution may still be rendered as an external bubble 1320, but identified by an external bubble identifier 1325 specifically indicating Grandpa as the contributor.

On the other hand, from the perspective of the grandparents' user supersystem 100, the Smiths contributions may all look as though they are originating from the same endpoint (e.g., the Smiths' user supersystem 100). As such, Mom's reply and Gaby's subsequent reply may both be rendered as external bubbles 1320 identified with the same external bubble identifier 1325 indicating the message as coming generally from the Smiths' home (i.e., even though Mom replied from her member device 820, and Gaby replied from the Smiths' user supersystem 100).

While the invention has been described with respect to exemplary embodiments, one skilled in the art will recognize that numerous modifications are possible. For example, the methods and processes described herein may be implemented using hardware components, software components, and/or any combination thereof Further, while various methods and processes described herein may be described with respect to particular structural and/or functional components for ease of description, methods of the invention are not limited to any particular structural and/or functional architecture but instead can be implemented on any suitable hardware, firmware, and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added, and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for displaying a group conversation transpiring over a communications network, the method comprising:
receiving a contribution message from one of at least three members of a conversation group via a sending device being one of a plurality of communications devices associated with the conversation group, the plurality of communications devices comprising:
a hub system associated with all the members of the conversation group and disposed within a local network; and
a plurality of member devices, each associated with one of the at least three members of the conversation group and configured to communicate with the hub system from locations external to the local network,
determining, at a rendering device, whether the sending device is the rendering device, the rendering device being one of the plurality of communications devices and comprising a display having a first region designated for rendering contribution messages originating from the rendering device and a second region designated for rendering contribution messages originating from other than the rendering device;
when the sending device is the rendering device, rendering the contribution message to the first region of the display; and
when the sending device is not the rendering device, rendering the contribution message to the second region of the display.

2. The method of claim 1, further comprising:
when the sending device is not the rendering device:
determining a graphical identifier corresponding to the sending device; and
rendering the graphical identifier to the display such that the graphical identifier is visually correlated to the contribution message rendered to the second region of the display.

3. The method of claim 2, wherein:
when the sending device is the hub system, the graphical identifier is designed to graphically indicate either the hub system or the conversation group; and
when the sending device is one of the plurality of member devices, the graphical identifier is designed to graphically indicate the one of the at least three members of the conversation group associated with the sending device.

4. The method of claim 2, wherein the graphical identifier comprises a set of alphanumeric characters designed to represent a party associated with the sending device.

5. The method of claim 2, wherein the graphical identifier comprises an image corresponding to a party associated with the sending device.

6. The method of claim 1, wherein rendering the contribution message to the first region of the display comprises:
displaying at least a portion of the contribution message in a sub-region of the first region of the display, the sub-region shaped substantially as a speech bubble oriented to point in a direction opposite the second region of the display.

7. The method of claim 1, wherein rendering the contribution message to the second region of the display comprises:
determining a graphical identifier corresponding to the sending device;
displaying at least a portion of the contribution message in a sub-region of the second region of the display, the sub-region shaped substantially as a speech bubble oriented to point in a direction opposite the first region of the display; and
displaying the graphical identifier in a graphical identifier region of the display, such that the graphical identifier is visually correlated to the sub-region of the second region of the display.

8. The method of claim 7, wherein the graphical identifier region of the display is located on the display directly adjacent to the sub-region of the second region of the display, such that the speech bubble is oriented to point substantially to the graphical identifier.

9. The method of claim 1, wherein the rendering the second contribution message comprises displaying the at least a portion of the second contribution message in a location relative to a previously received contribution message that indicates a temporal relationship between the first contribution message and the previously received contribution message.

10. The method of claim 1, wherein the rendering the first contribution message comprises displaying multimedia information comprised by the first contribution message.

11. A hub system for displaying a group conversation transpiring over a communications network, the hub system disposed within a local portion of the communications network, the hub system comprising:
an input subsystem, configured to receive a first contribution message via an input device from a first member of a conversation group comprising at least three members;
a contribution processing subsystem, communicatively coupled with the input subsystem, and configured to:
receive the first contribution message from the first member of the conversation group via the input subsystem; and
receive a second contribution message from a second member of the conversation group via a member device, the hub system associating the member device with the second member; and
an output subsystem, communicatively coupled with the contribution processing subsystem, and configured to:
display at least a portion of the first contribution message to a first region of a display device, the first region designated for displaying contribution messages originating from the input subsystem as internal messages; and
display at least a portion of the second contribution message to a second region of the display device, the second region designated for displaying contribution messages originating from other than the input subsystem as external messages.

12. The hub system of claim 11, the contribution processing subsystem further configured to:
identify the first contribution message as an internal message; and
identify the second contribution message as an external message.

13. The hub system of claim 11, the output subsystem further configured to:
arrange the display of the at least a portion of the first contribution message and the display of the at least a portion of the second contribution message to indicate a temporal relationship between the first contribution message and the second contribution message.

14. The hub system of claim 11, the output subsystem further configured to:
display the at least a portion of the first contribution message in a sub-region of the first region of the display, the sub-region shaped substantially as a speech bubble oriented to point in a direction opposite the second region of the display.

15. The hub system of claim 11, the output subsystem further configured to:
determine a graphical identifier corresponding to the member device; and
display the graphical identifier in substantial visual correspondence with the second contribution message.

16. The hub system of claim 15, the output subsystem further configured to:
display the at least a portion of the second contribution message in a sub-region of the second region of the display, the sub-region shaped substantially as a speech bubble oriented to point in a direction opposite the first region of the display and toward the graphical identifier.

17. The hub system of claim 15, the output subsystem further configured to:
display multimedia content comprised by the first contribution message in the first region of the display; and
display multimedia content comprised by the second contribution message in the second region of the display.

18. The hub system of claim 11, wherein:
the contribution processing subsystem is further configured to receive a third contribution message from a third member of the conversation group via a second member device, the hub system associating the second member device with the third member; and
the output subsystem is further configured to display at least a portion of the third contribution message to the second region of the display device.

19. The hub system of claim 11, further comprising:
a first client subsystem comprising a housing configured substantially as a tablet computing environment, at least the contribution processing subsystem and the output subsystem being integrated with the housing;
a second client subsystem comprising a housing configured substantially as a handheld computing environment; and
a base station system, comprising:
a first interface subsystem configured to communicatively and removably couple the base station with the housing of the first client subsystem; and
a second interface subsystem configured to communicatively and removably couple the base station with the housing of the second client subsystem.

20. A member device for displaying a group conversation transpiring over a communications network, the member device comprising:
an input subsystem, configured to receive a first contribution message via an input device from a first member of a conversation group comprising at least three members;
a contribution processing subsystem, communicatively coupled with the input subsystem, and configured to:
receive the first contribution message from the first member of the conversation group via the input subsystem; and
receive a second contribution message from a second member of the conversation group via a hub system associated with the conversation group;
receive a third contribution message from a third member of the conversation group via a second member device;
determine a first graphical identifier corresponding to the hub system; and
determine a second graphical identifier corresponding to the second member device; and
an output subsystem, communicatively coupled with the contribution processing subsystem, and configured to:
render the first contribution message to a first region of a display device by displaying an unidentified speech bubble containing at least a portion of the first contribution message;
render the second contribution message to a second region of the display device by displaying a first identified speech bubble containing at least a portion of the second contribution message and displaying the first graphical identifier in visual correspondence with the first identified speech bubble; and
render the third contribution message to the second region of the display device by displaying a second identified speech bubble containing at least a portion of the third contribution message and displaying the second graphical identifier in visual correspondence with the first identified speech bubble.
